(19) United States
(12) Patent Application Publication
(10) Pub. No.: US 2026/0094154 A1
(43) Pub. Date: Apr. 2, 2026

(54) BLOCKCHAIN-BASED BUSINESS DATA PROCESSING METHOD, EQUIPMENT, AND STORAGE MEDIUM

(71) Applicant: iCALC Holdings Limited, Hong Kong (CN)

(72) Inventor: HoMan POON, Hong Kong (CN)

(21) Appl. No.: 18/930,174

(22) Filed: Oct. 29, 2024

(30) Foreign Application Priority Data
Sep. 27, 2024 (CN) 202411361942.2

(51) Int. Cl. G06Q 20/40; G06F 40/30; G06Q 30/04; G06V 30/148

(52) U.S. Cl. CPC G06Q 20/401; G06F 40/30; G06Q 30/04; G06V 30/153; G06Q 2220/00

(57) ABSTRACT

A blockchain-based business data processing method includes: obtaining pending-transaction business data sent by a first object, and generating an initial transaction contract and sending the initial transaction contract to the first object, so that the first object generates feedback information; obtaining an updated transaction contract according to the feedback information; generating a transaction order, sending the transaction order to the first object, and sending first invoicing critical data in the transaction order to an invoicing node in blockchain, so that the invoicing node generates a first block to-be-chained; in response to detecting that a second block to-be-chained has been created and passing verification of data in the second block, sequentially chaining the two blocks, generating a first electronic invoice according to the chained first block and sending the first electronic invoice to the first object, and updating an account balance according to the chained second block.

### CROSS-REFERENCE TO RELATED APPLICATION(S)

This application claims priority to Chinese Patent Application No. 202411361942.2, filed Sep. 27, 2024, the disclosure of which is hereby incorporated by reference in its entirety.

### TECHNICAL FIELD

This application relates to the field of computer technology, and particularly to a blockchain-based business data processing method, equipment, and a storage medium.

### BACKGROUND

In today's digital age, issuance and management of financial invoices has become an indispensable part of corporate operations. With advancement of “Internet+” technology and market development, electronic invoices have gradually replaced traditional paper invoices and become a mainstream form of invoices. At present, issuance of invoices generally requires manual assistance. However, in the case of heavy invoicing workload, problems such as incomplete, non-standard, or unclear invoice contents may occur, including missing purchaser information, unspecific names of product or service, etc., and invoicing efficiency during invoicing is not high.

### SUMMARY

In a first aspect, embodiments of the disclosure provide a blockchain-based business data processing method. The method includes: obtaining pending-transaction business data sent by a first object, obtaining a predicted transaction price for the pending-transaction business data by performing price prediction on the pending-transaction business data, generating an initial transaction contract according to the predicted transaction price and the pending-transaction business data, and sending the initial transaction contract to the first object, the initial transaction contract being used for the first object to generate feedback information; obtaining the feedback information sent by the first object, predicting, according to the feedback information, contract update data that meets a transaction-success-rate condition, and obtaining an updated transaction contract by updating the initial transaction contract according to the contract update data; generating a transaction order according to the updated transaction contract, sending the transaction order to the first object, and sending first invoicing critical data in the transaction order to an invoicing node in blockchain, the first invoicing critical data being used for the invoicing node to generate a first block to-be-chained; the transaction order containing the updated transaction contract and a contract signature generated for the updated transaction contract; in response to detecting that a second block to-be-chained has been created at the invoicing node, verifying transaction data and transaction signature in the second block; the transaction data indicating to transfer transaction funds in an account address of the first object to an account address of a main object, and a parent block hash in a block header of the second block being a block hash of the first block; and in response to verifying that a value of transaction funds in the transaction data matches a value of contract funds in the updated transaction contract and the transaction signature is identical with the contract signature, sequentially chaining the first block and the second block, generating, according to the chained first block, a first electronic invoice corresponding to the transaction order and sending the first electronic invoice to the first object, and updating, according to the chained second block, an account balance of the first object and an account balance of the main object in a state tree of the blockchain.

In a second aspect, embodiments of the disclosure provide a computer equipment. The computer equipment includes a processor and a memory. The memory is connected with the processor and stores computer programs which, when executed by the processor, cause the processor to execute the method in the first aspect.

In a third aspect, embodiments of the disclosure provide a non-transitory computer-readable storage medium. The non-transitory computer-readable storage medium stores computer programs which, when executed by a processor, cause a computer equipment to execute the method in the first aspect.

### BRIEF DESCRIPTION OF THE DRAWINGS

In order to describe technical solutions of embodiments of the disclosure or the related art more clearly, the following will give a brief description of accompanying drawings used for describing the embodiments or the related art. Apparently, accompanying drawings described below are merely some embodiments. Those of ordinary skill in the art can also obtain other accompanying drawings based on the accompanying drawings described below without creative efforts.

FIG. 1 is a network interaction architecture diagram provided in embodiments of the disclosure.

FIG. 2 is a schematic scenario diagram illustrating a blockchain-based business data processing method provided in embodiments of the disclosure.

FIG. 3 is a flowchart illustrating a blockchain-based business data processing method provided in embodiments of the disclosure.

FIG. 4 is a flowchart illustrating a blockchain-based business data processing method provided in other embodiments of the disclosure.

FIG. 5 is a schematic diagram illustrating a blockchain-based business data processing device provided in embodiments of the disclosure.

FIG. 6 is a schematic structural diagram illustrating a computer equipment provided in embodiments of the disclosure.

### DETAILED DESCRIPTION

Hereinafter, technical solutions of embodiments of the disclosure will be described clearly and completely with reference to accompanying drawings in the embodiments. Apparently, embodiments described below are merely some embodiments, rather than all embodiments of the disclosure. All other embodiments obtained by those of ordinary skill in the art based on the embodiments without creative efforts shall fall within the protection scope of the disclosure.

If it is necessary to collect data of an object (e.g., a user) in the disclosure, a prompt interface or a pop-up window will be displayed before or during collection. The prompt interface or the pop-up window is used to prompt the user that certain data is currently being collected. Only when an acknowledgment operation for the prompt interface or the pop-up window is obtained from the user, operations related to data collection will be executed; otherwise, the operations related to data collection will not be executed. Moreover, the obtained user data will be used in reasonable and legal scenarios or for reasonable and legal purposes. Optionally, in some scenarios where user data needs to be used but not authorized by the user, authorization from the user can be requested, and the user data can be used once the authorization is granted.

It is to be understood that, the user data involved in specific embodiments of the disclosure, when the following embodiments of the disclosure are applied to specific products or technologies, requires obtaining user permission or consent, and collection, use, and processing of relevant data need to comply with the relevant laws, regulations, and standards of the relevant regions.

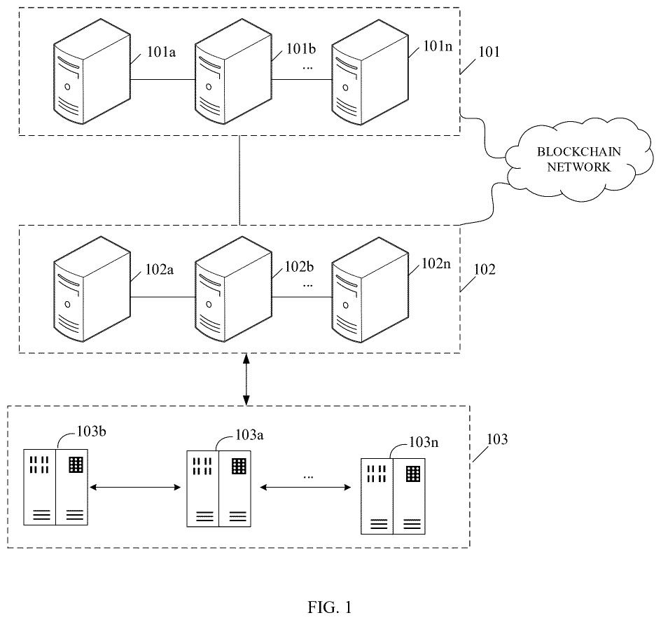

In embodiment of the disclosure, referring to FIG. 1, FIG. 1 is a network interaction architecture diagram provided in embodiments of the disclosure. Blockchain is a new application mode of computer technology such as distributed data storage, point-to-point transmission, consensus mechanism, and encryption algorithm. Blockchain is mainly used to organize data in chronological order and encrypt data into a ledger to make data tamper-proof and forge-resistant, and can also allow for data verification, storage, and updating. Blockchain is essentially a decentralized database. Each node in the database stores an identical copy of blockchain. A blockchain network categorizes nodes into core nodes, data nodes, and light nodes, where the core node is responsible for consensus across the entire blockchain network, that is, the core node serves as a consensus node in the blockchain network. The process of writing data or a generated block(s) in the blockchain network into the ledger can be that: a client sends data or a generated block(s) to a data node or a light node, and then, the data or the generated block is passed among data nodes or light nodes in the blockchain network in a relay manner until a consensus node receives the data or the generated block, and further, the consensus node packages the data into a block and engages in consensus with other consensus nodes, and finally, a block carrying the data is written into the ledger once consensus is reached.

As illustrated in FIG. 1, the network architecture involves a core node cluster 101, a data node cluster 102, and a user terminal cluster 103. As illustrated in FIG. 1, the core node cluster 101, for example, includes a core node 101a, a core node 101b . . . a core node 101n; the data node cluster 102, for example, includes a data node 102a, a data node 102b . . . a data node 102n; and the user terminal cluster 103, for example, includes a user terminal 103a, a user terminal 103b . . . a user terminal 103n.

As illustrated in FIG. 1, the user terminal 103a, the user terminal 103b . . . and the user terminal 103n each can establish network connection with the data node 102a, the data node 102b . . . and the data node 102n, so that the user terminal can interact with the data node(s) through the network connection. The data node 102a, the data node 102b . . . and the data node 102n each can establish network connection with the core node 101a, the core node 101b . . . and the core node 101n, so that the data node can interact with the core node(s) through the network connection. The data node 102a, the data node 102b . . . and the data node 102n are connected to each other, so that data interaction among these data nodes can be performed; the core node 101a, the core node 101b and the core node 101n are connected to each other, so that data interaction among these core nodes can be performed.

In an example where the user terminal 103a, the data node 102a, and the core node 101a are involved, the data node 102a can receive data sent by the user terminal 103a, the data node 102a can package the data to generate a block, and further send the block to the core node 101a through the data node cluster 102; then, the core node 101a can send, according to node identifiers of other core nodes (i.e., consensus nodes) in a blockchain network where the core node 101a is located, the block to said other core nodes, said other core nodes perform verification (consensus) on the newly generated block, and add the block to a ledger to which said other core nodes belong after the verification is completed. Each core node in the blockchain network has a corresponding node identifier, and each core node in the blockchain network can store node identifiers of other core nodes in the blockchain network, so that the generated block can be broadcast to other core nodes in the blockchain network according to node identifiers of other core nodes. Other core nodes will conduct a consensus on the newly generated block and add the newly generated block to a ledger to which other core nodes belong once the consensus is reached. In this way, all core nodes in the blockchain network store same transaction data.

For ease of understanding, a user terminal corresponding to a first object (i.e., a user) is, for example, the user terminal 103b in FIG. 1, and a user terminal corresponding to a main object is, for example, the user terminal 103a in FIG. 1, the user terminal 103a and the user terminal 103b each are equipped with a resource client, where the resource client is used to implement a service function for resource management, and establish communication connection with a decentralized application client based on the service function for resource management. The resource client herein is a tool for managing and storing user digital assets, as an example, digital assets are transferred to other accounts through the resource client; as another example, digital assets transferred from other accounts are received through the resource client. The resource client may be a hardware device or a software program. It is to be understood that, with widespread deployment of various decentralized applications on the blockchain, user activities on the blockchain have increased. When using a decentralized application, users can generally use a blockchain key management tool to log in. The address in the blockchain key management tool corresponds to a user on the blockchain, and the decentralized application can obtain the user address from the key management tool through certain interfaces.

The user terminal 103a can obtain pending-transaction business data sent by the first object (the user terminal 103b), where the pending-transaction business data may include items that the first object needs to rent or purchase from the main object corresponding to the user terminal 103a, as well as the quantity of these items. The user terminal 103a can obtain a predicted transaction price for the pending-transaction business data by performing price prediction on the pending-transaction business data through a price list prepared by the main object in advance or a trained price prediction model. An initial transaction contract can be generated according to the predicted transaction price and the pending-transaction business data, and the initial transaction contract can be sent to the user terminal 103b corresponding to the first object. After receiving the initial transaction contract, the first object can read and determine transaction contents and the predicted transaction price, etc. in the initial transaction contract, generate feedback information according to the initial transaction contract, and send the feedback information to the user terminal 103a. If the first object has doubts about the predicted transaction price (e.g., the predicted transaction price is considered not to meet psychological expectations), the feedback information includes feedback on the predicted transaction price (e.g., the predicted transaction price is considered too high, and request a price reduction or feedback on an expected transaction price, etc.)

The user terminal 103a can obtain the feedback information sent by the first object, and predict, according to the feedback information, contract update data that meets a transaction-success-rate condition. For example, the user terminal 103a determines, according to the feedback information and the predicted transaction price, a transaction price that meets a certain transaction-success-rate condition (e.g., an expected transaction rate reaches 85%) and greatly satisfies its own benefits, and determines the determined transaction price as the contract update data. An updated transaction contract can be obtained by updating the initial transaction contract according to the contract update data. The user terminal 103a can generate a transaction order according to the updated transaction contract, send the transaction order to the first object, and send first invoicing critical data in the transaction order to an invoicing node in blockchain (e.g., the data node 102a in FIG. 1), so that the invoicing node generates a first block to-be-chained according to the first invoicing critical data. The transaction order may contain the updated transaction contract and a contract signature generated for the updated transaction contract. The transaction order may be a transaction invitation containing the updated transaction contract and the contract signature generated for the updated transaction contract, that is, the transaction takes effect when the first object agrees to the transaction invitation. When the user terminal 103a detects that a second block to-be-chained has been created at the invoicing node, that is, after the first object agrees to the transaction order (or the updated transaction contract is signed), the user terminal 103b sends transaction information (containing the transaction order, transaction data and a transaction signature for the transaction order, etc.) for the transaction order to the invoicing node. The invoicing node can determine a block hash of the first block as a parent block hash, generate a block body according to the transaction information, and create the second block according to the parent block hash and the block body. In this situation, the second block can be detected at the invoicing node. The user terminal 103a can verify the transaction data and the transaction signature in the second block, where the transaction data indicates to transfer transaction funds in an account address of the first object to an account address of a main object (an object corresponding to the user terminal 103a). In response to verifying that a value of transaction funds in the transaction data matches a value of contract funds in the updated transaction contract and the transaction signature is identical with the contract signature, the first block and the second block are chained sequentially, a first electronic invoice corresponding to the transaction order is generated according to the chained first block and the first electronic invoice is sent to the first object. An account balance of the first object and an account balance of the main object in a state tree of the blockchain are updated according to the chained second block.

It is to be understood that, the user terminal involved in embodiments of the disclosure may also be a computer equipment. The computer equipment in embodiments of the disclosure includes, but is not limited to, a terminal device or a server. In other words, the computer equipment may be a server or a terminal device, or may be a system composed of a server and a terminal device. The above terminal device may be an electronic device, including but not limited to a mobile phone, a tablet computer, a desktop computer, a laptop computer, a personal digital assistant (PDA), a vehicle-mounted device, an augmented reality/virtual reality (AR/VR) device, a helmet display, a smart TV, a wearable device, a smart speaker, a digital camera, a camera, and other mobile Internet devices (MID) with network access capabilities, or a terminal device in scenarios such as trains, ships, and flights. The above server may be an independent physical server, or a distributed system or a server cluster composed of multiple physical servers, or a cloud server that provides basic cloud computing services such as cloud services, cloud databases, cloud computing, cloud functions, cloud storage, network services, cloud communications, middleware services, domain name services, security services, vehicle-road collaboration, content delivery networks (CDN), and big data and artificial intelligence platforms.

As such, the initial transaction contract is generated according to the pending-transaction business data and the predicted transaction price for the pending-transaction business data, the feedback information is obtained by directly sending the initial transaction contract to the first object, and the updated transaction contract is obtained by updating the initial transaction contract according to the feedback information, which can avoid unnecessary multiple information interaction processes, thereby improving transaction efficiency and shortening transaction completion time; furthermore, after the transaction order is generated, a corresponding first block to-be-chained is generated according to the first invoicing critical data corresponding to the transaction order, so that in response to detecting that the second block (containing the transaction data for the transaction order) has been created, that is, when the first object agrees to the transaction order, a corresponding electronic invoice can be obtained by quickly and directly chaining the two blocks, thereby improving invoicing efficiency.

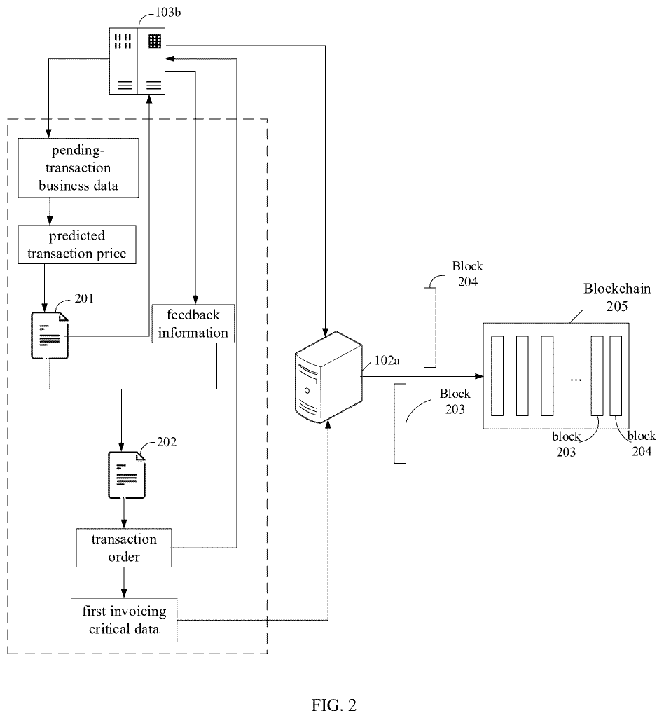

Specifically, referring to FIG. 2, FIG. 2 is a schematic scenario diagram illustrating a blockchain-based business data processing method provided in embodiments of the disclosure. As illustrated in FIG. 2, a user terminal 103a can obtain pending-transaction business data sent by a user terminal 103b (a first object), obtain a predicted transaction price by performing price prediction on the pending-transaction business data, generate an initial transaction contract 201 according to the predicted transaction price and the pending-transaction business data, and send the initial transaction contract 201 to the user terminal 103b. After receiving the initial transaction contract 201, the user terminal 103b can generate feedback information according to the initial transaction contract 201, and send the feedback information to the user terminal 103a. After receiving the feedback information, the user terminal 103a can predict, according to the feedback information, contract update data that meets a transaction-success-rate condition, and obtain an updated transaction contract 202 by updating the initial transaction contract 201 according to the contract update data. The user terminal 103a can generate a transaction order according to the updated transaction contract 202, where the transaction order contains the updated transaction contract and a contract signature generated for the updated transaction contract. The user terminal 103a can send the transaction order to the user terminal 103b, and send first invoicing critical data in the transaction order to an invoicing node in blockchain (e.g., a data node 102a in FIG. 1), so that the invoicing node generates a first block to-be-chained (e.g., a block 203) according to the first invoicing critical data.

In response to detecting that a second block to-be-chained (e.g., a block 204) has been created at the invoicing node, that is, when the user terminal 103b receives the transaction order, after the first object agrees to the transaction order, the user terminal 103b sends transaction information (containing transaction data and a transaction signature) corresponding to the transaction order to the invoicing node, so that the invoicing node creates the second block according to the transaction information, and in this case, the user terminal 103a can detect that the second block to-be-chained has been created at the invoicing node, and further verify the transaction data and the transaction signature in the second block. The transaction data indicates to transfer transaction funds in an account address of the first object to an account address of the main object. A parent block hash in a block header of the second block is a block hash of the first block. In response to verifying that a value of transaction funds in the transaction data matches a value of contract funds in the updated transaction contract and the transaction signature is identical with the contract signature, the first block and the second block are chained sequentially, that is, the invoicing node (the data node 102a) sends the block 203 and the block 204 to a core node (a consensus node) for consensus, and these blocks (including the block 203 and the block 204) are added to a ledger to which the core node belongs after the consensus is reached, that is, the block 203 and the block 204 have been chained in blockchain 205. The user terminal 103a can generate a first electronic invoice corresponding to the transaction order according to the chained first block, send the first electronic invoice to the first object (the user terminal 103b), and update an account balance of the first object and an account balance of the main object in a state tree of the blockchain 205 according to the chained second block.

As such, the initial transaction contract is generated according to the pending-transaction business data and the predicted transaction price for the pending-transaction business data, the feedback information is obtained by directly sending the initial transaction contract to the first object, and the updated transaction contract is obtained by updating the initial transaction contract according to the feedback information, which can avoid unnecessary multiple information interaction processes, thereby improving transaction efficiency and shortening transaction completion time; furthermore, after the transaction order is generated, a corresponding first block to-be-chained is generated according to the first invoicing critical data corresponding to the transaction order, so that in response to detecting that the second block (containing the transaction data for the transaction order) has been created, that is, when the first object agrees to the transaction order, a corresponding electronic invoice can be obtained by quickly and directly chaining the two blocks, thereby improving invoicing efficiency.

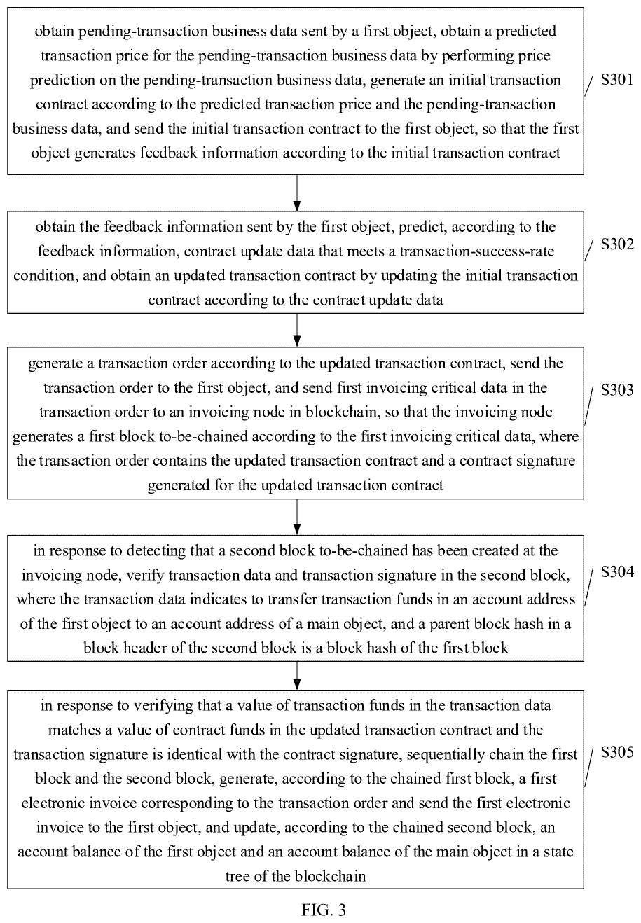

Further, referring to FIG. 3, FIG. 3 is a flowchart illustrating a blockchain-based business data processing method provided in embodiments of the disclosure. The blockchain-based business data processing method may be executed by a computer equipment, and the computer equipment can be any user terminal in the user terminal (device) cluster illustrated in FIG. 1. The following will depict examples where the data processing method is executed by a computer equipment. The data processing method at least includes the following operations S301-S305.
S301, obtain pending-transaction business data sent by a first object, obtain a predicted transaction price for the pending-transaction business data by performing price prediction on the pending-transaction business data, generate an initial transaction contract according to the predicted transaction price and the pending-transaction business data, and send the initial transaction contract to the first object, so that the first object generates feedback information according to the initial transaction contract.

In embodiments of the disclosure, the computer equipment may obtain the pending-transaction business data sent by the first object, and obtain the predicted transaction price for the pending-transaction business data by performing price prediction on the pending-transaction business data. The pending-transaction business data may be items that the first object needs to purchase or rent and the quantity of items that need to be purchased or rented. The computer equipment may obtain a selling price or a rental price of a single item set in advance by the owner of the items, and calculate the predicted transaction price for the pending-transaction business data. Optionally, the computer equipment calls a trained price prediction model, and obtains the predicted transaction price for the pending-transaction business data by performing price prediction on one or more items in the pending-transaction business data through the price prediction model. The computer equipment may obtain a contract template associated with the pending-transaction business data from a business template library, and generate the initial transaction contract according to the contract template, the pending-transaction business data, and the predicted transaction price through a text-to-image model. It is to be understood that, the initial transaction contract also contains identity information, account information, signatures, and other details of two parties involved in the transaction. The computer equipment may send the initial transaction contract to the first object, so that the first object generates the feedback information according to the initial transaction contract. That is, after receiving the initial transaction contract, the first (business) object checks contract contents of the initial transaction contract, generates the feedback information according to the contract contents, and sends the feedback information to the computer equipment. The feedback information may be opinion information on the predicted transaction price in the initial transaction contract, for example, the feedback information may be an expected transaction price proposed by the first object, or information indicating that the predicted transaction price is too high and a discount or price reduction is required.
S302, obtain the feedback information sent by the first object, predict, according to the feedback information, contract update data that meets a transaction-success-rate condition, and obtain an updated transaction contract by updating the initial transaction contract according to the contract update data.

In embodiments of the disclosure, the computer equipment may obtain the feedback information sent by the first object, and predict the contract update data that meets the transaction-success-rate condition according to the feedback information. It is to be understood that, in order to maximize benefits, the contract update data predicted by the computer equipment is the highest price among multiple transaction prices that meet a certain transaction-success-rate condition (e.g., the probability of reaching a transaction with the first object reaches 90%). As an example, the transaction price of 2000 and the transaction price of 2100 each can meet the transaction-success-rate condition of 90%, since the transaction price of 2100 is higher than the transaction price of 2000, the transaction price of 2100 is determined as the contract update data. Further, the computer equipment may update the initial transaction contract according to the contract update data, that is, replacing the predicted transaction price in the initial transaction contract with the contract update data, to obtain the updated transaction contract.
S303, generate a transaction order according to the updated transaction contract, send the transaction order to the first object, and send first invoicing critical data in the transaction order to an invoicing node in blockchain, so that the invoicing node generates a first block to-be-chained according to the first invoicing critical data, where the transaction order contains the updated transaction contract and a contract signature generated for the updated transaction contract.

In embodiments of the disclosure, the computer equipment may generate the transaction order according to the updated transaction contract, and the transaction order contains the updated transaction contract and the contract signature generated for the updated transaction contract. The contract signature is a digital signature obtained by encrypting a contract digest with a private key of an object (main object) corresponding to the computer equipment, and the contract digest is obtained by hashing the updated transaction contract through a hash function. The computer equipment may send the transaction order to the first object. The transaction order, for example, is a transaction page. After confirming that the transaction order is correct, the first object can directly click a button or a component indicative of agreement to the transaction in the transaction page, so that the transaction order takes effect. When sending the first invoicing critical data in the transaction order to the first object, the computer equipment also needs to send the transaction order to the invoicing node in the blockchain, so that the invoicing node generates the first block to be-chained according to the first invoicing critical data. The first invoicing critical data includes information on an invoicing party (the object corresponding to the computer equipment) and an invoice recipient (the first object), billing business (pending-transaction business data), billing amount (contract update data), date, etc. The first block consists of a block header and a block body. The block header contains a version number, a hash value of a previous block in the blockchain, a timestamp, a difficulty value, and a nonce, etc. The block body is used to store a hash value of the first invoicing critical data.
S304, in response to detecting that a second block to-be-chained has been created at the invoicing node, verify transaction data and transaction signature in the second block, where the transaction data indicates to transfer transaction funds in an account address of the first object to an account address of a main object, and a parent block hash in a block header of the second block is a block hash of the first block.

In embodiments of the disclosure, when detecting that the second block to-be-chained has been created at the invoicing node, the computer equipment verifies the transaction data and transaction signature in the second block. The parent block hash in the block header of the second block is the block hash of the first block (a hash value of the first block). The transaction data indicates to transfer the transaction funds in the account address of the first object to the account address of the main object (the object corresponding to the computer equipment). Specifically, the computer equipment obtains storage information in the second block, where the storage information includes transaction data and a transaction signature. The computer equipment obtains transaction funds in the transaction data, and compares a value of the transaction funds with a value of a contract funds (i.e., contract update data) in the updated transaction contract. If the value of the transaction funds is identical with the value of the contract funds, the value of the transaction funds in the transaction data is considered to match the value of the contract funds in the updated transaction contract. Further, the computer equipment obtains a public key of the main object, obtains a transaction digest corresponding to the transaction signature by decrypting the transaction signature with the public key of the main object, and compares the transaction digest with the contract digest mentioned above to verify whether the transaction digest is identical with the contract digest.
S305, in response to verifying that a value of transaction funds in the transaction data matches a value of contract funds in the updated transaction contract and the transaction signature is identical with the contract signature, sequentially chain the first block and the second block, generate, according to the chained first block, a first electronic invoice corresponding to the transaction order and send the first electronic invoice to the first object, and update, according to the chained second block, an account balance of the first object and an account balance of the main object in a state tree of the blockchain.

In embodiments of the disclosure, if the computer equipment verifies that the value of the transaction funds in the transaction data matches the value of the contract funds in the updated transaction contract and the transaction signature is identical with the contract signature, the computer equipment sequentially chains the first block and the second block, that is, the first block and the second block at the invoicing node are sent to a consensus node in the blockchain for consensus, and the chaining of the first block and the second block is completed after the consensus is completed. The computer equipment can generate the first electronic invoice corresponding to the transaction order according to the chained first block, and send the first electronic invoice to the first object. The computer equipment can update, according to the chained second block, the account balance of the first object and the account balance of the main object in the state tree of the blockchain, that is, digital assets corresponding to transaction funds that needs to be paid by the first object are transferred from an account of the first object to an account of the main object to complete a payment operation. Optionally, the computer equipment may further create a trustworthy asset certificate (Token) for the digital assets corresponding to the transaction funds, and send the trustworthy asset certificate to the first object. The trustworthy asset certificate indicates payables owed by the first object to the main object (i.e., the digital assets corresponding to the transaction funds). After digital assets corresponding to/equivalent to the transaction funds are transferred form the account balance of the first object to the account balance of the main object, the trustworthy asset certificate can be transferred to the account of the main object, indicating that receivables of the main object from the first object have been settled. As an example, if the main object sells a product worth 1,000 ¥ to the first object, the main object can create an equivalent-value token for the first object. This token represents payables of 1,000 ¥ owed by the first object to the main object. Once the first object makes a payment, this token will be transferred to the account of the main object, indicating that the receivables have been settled.

As such, the initial transaction contract is generated according to the pending-transaction business data and the predicted transaction price for the pending-transaction business data, the feedback information is obtained by directly sending the initial transaction contract to the first object, and the updated transaction contract is obtained by updating the initial transaction contract according to the feedback information, which can avoid unnecessary multiple information interaction processes, thereby shortening transaction completion time; in addition, after the transaction order is generated, a corresponding first block to-be-chained is generated according to the first invoicing critical data corresponding to the transaction order, so that in response to detecting that the second block (containing the transaction data for the transaction order) has been created, that is, when the first object agrees to the transaction order, a corresponding electronic invoice can be obtained by directly chaining the two blocks, thereby improving invoicing efficiency. Furthermore, the first invoicing critical data obtained by the computer equipment from the transaction order includes all critical data for generating the electronic invoice, thereby reducing omission rate of manually obtaining the first invoicing critical data; moreover, the first invoicing critical data is automatically inputted by the computer equipment into the electronic invoice template to generate the final electronic invoice, which not only reduces time required for manual input but also lowers an error rate.

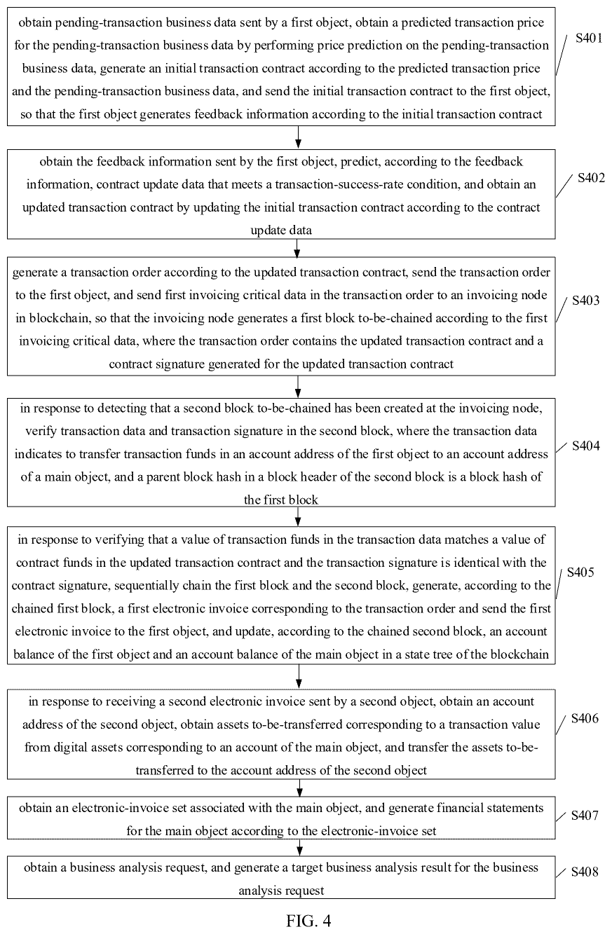

Further, referring to FIG. 4, FIG. 4 is a flowchart illustrating a blockchain-based business data processing method provided in other embodiments of the disclosure. The blockchain-based business data processing method may be executed by a computer equipment, and the computer equipment can be any user terminal in the user terminal (device) cluster illustrated in FIG. 1. The following will depict examples where the data processing method is executed by a computer equipment. The data processing method at least includes the following operations S401-S408.
S401, obtain pending-transaction business data sent by a first object, obtain a predicted transaction price for the pending-transaction business data by performing price prediction on the pending-transaction business data, generate an initial transaction contract according to the predicted transaction price and the pending-transaction business data, and send the initial transaction contract to the first object, so that the first object generates feedback information according to the initial transaction contract.

In embodiments of the disclosure, the computer equipment can obtain the pending-transaction business data sent by the first object, and obtain the predicted transaction price for the pending-transaction business data by performing price prediction on the pending-transaction business data. The pending-transaction business data may be items that the first object needs to purchase or rent and the quantity of items that need to be purchased or rented. The computer equipment may obtain a selling price or a rental price of a single item set in advance by the owner of the items, and calculate the predicted transaction price for the pending-transaction business data. Optionally, the computer equipment calls a trained price prediction model, and obtains the predicted transaction price for the pending-transaction business data by performing price prediction on one or more items in the pending-transaction business data through the price prediction model. The computer equipment may obtain a contract template associated with the pending-transaction business data from a business template library, and generate a Gaussian noise image according to the contract template and initial noise data, and obtain an instruction text by performing semantic expansion on the predicted transaction price and the pending-transaction business data through a large language model. As an example, the instruction text may be expressed as “using the predicted transaction price and the pending-transaction business data as specific data contents of the contract”. The computer equipment may input the Gaussian noise image and the instruction text into a text-to-image model, and obtain a mean vector and a variance vector of the Gaussian noise image by performing feature extraction on the Gaussian noise image through the text-to-image model. The mean vector represents the average of all pixel values of the Gaussian noise image over different channels, that is, the first-order statistic of the Gaussian noise image. The variance vector represents the average of variances of pixel values over each channel, that is, the second-order statistic of the Gaussian noise image. The computer equipment may obtain a potential mean vector and a potential variance vector by perform random sampling on the mean vector and the variance vector of the Gaussian noise image, and generate a Gaussian noise feature according to the potential mean vector and the potential variance vector.

Further, the computer equipment may obtain a latent variable distribution in a forward diffusion network layer of the text-to-image model, where the latent variable distribution is a conceptual distribution with added noise, such as a Gaussian distribution. The computer equipment may obtain a forward noise vector by continuously adding a random noise vector to the Gaussian noise feature over T time steps, where T is a positive integer, the time step refers to the amplitude of noise added to the Gaussian noise feature according to the latent variable distribution, and the noise refers to unnecessary or redundant interference information existing in the image data. When T is large enough, the forward noise vector can represent an image that completely dominated by noise. Further, the computer equipment may obtain a text encoding feature by performing feature encoding on the instruction text through a text encoding layer in the text-to-image model. Specifically, the computer equipment obtains a token sequence corresponding to the instruction text by performing text segmentation on the instruction text through the text encoding layer, and obtains a text encoding feature(s) by encoding each token in the token sequence corresponding to the instruction text. The token in the token sequence refers to the smallest basic unit obtained after a target frame text is segmented. The method for text segmentation may be word-based segmentation, character-based segmentation, or subword-based segmentation, which is not limited in embodiments of the disclosure. Further, the computer equipment may obtain the initial transaction contract by denoising the Gaussian noise image according to the forward noise vector and the text encoding feature. That is, the computer equipment obtains a predicted noise vector by continuously performing noise prediction on the forward noise vector through the text encoding feature over T time steps, and obtains a target latent vector by denoising the forward noise vector through the predicted noise vector. The computer equipment obtains a target predicted image by performing image reconstruction on the target latent vector through a decoder in the text-to-image model, and determines the target predicted image as the initial transaction contract. The computer equipment may send the initial transaction contract to the first object, so that the first object generates a corresponding feedback information according to the initial transaction contract. The feedback information may be opinion information on the predicted transaction price in the initial transaction contract, for example, the feedback information may be an expected transaction price proposed by the first object, or information indicating that the predicted transaction price is too high and a discount or price reduction is required.
S402, obtain the feedback information sent by the first object, predict, according to the feedback information, contract update data that meets a transaction-success-rate condition, and obtain an updated transaction contract by updating the initial transaction contract according to the contract update data.

In embodiments of the disclosure, the computer equipment may obtain the feedback information sent by the first object, obtain feedback semantic data by performing semantic analysis on the feedback information, and generate an object expected price according to the feedback semantic data, where the object expected price refers to a psychological expected price of the first object derived by analyzing the feedback information. The computer equipment may obtain a price update parameter, and generate, according to the object expected price, the predicted transaction price, and the price update parameter, M transaction prices to-be-updated, where M is a positive integer. The price update parameter may be set manually. As an example, if the price update parameter is set to 100, the object expected price is 2400, and the predicted transaction price is 3000, then M is 6, and accordingly, the M transaction prices to-be-updated are “2400, 2500, 2600, 2700, 2800, and 2900” respectively. The computer equipment may obtain historical completed transaction behavior data corresponding to each of the M transaction prices to-be-updated, that is, from historical transaction behavior data of a transaction price to-be-updated, historical completed transaction behavior data corresponding to the transaction price to-be-updated is obtained, the historical completed transaction behavior data includes successfully traded items, the quantity of the items, transaction time, transaction objects, etc.

The computer equipment may obtain M historical transaction behavior features by performing feature extraction on M historical completed transaction behavior data, obtain a transaction-pending business feature by performing feature extraction on the pending-transaction business data, and obtain M cross-attention scores by performing cross-attention processing on the transaction-pending business feature and the M historical transaction behavior features. A possible method for cross-attention processing can be referred to as formula \textcircled{1}:

$$Attention ( Q , K , V ) = softmax ( \frac{Q {K}^{T}}{\sqrt{{d}_{k}}} ) V \qquad ○ 1$$

As illustrated in formula \textcircled{1}, Attention(Q, K, V) represents a cross-attention function, Q represents a query vector, K represents a key vector, and V represents a value vector, T represents transposition, K^{T} represents a transposition matrix of K, and dₖ represents the number of dimensions corresponding to the transaction-pending business feature. The computer equipment can determine the M historical transaction behavior features as the query vector, and determine the transaction-pending business feature as the key vector and the value vector. A cross-attention score sequence can be obtained through formula \textcircled{1}, where the cross-attention score sequence contains the M cross-attention scores.

The computer equipment may determine an attention score threshold according to the transaction-success-rate condition, and form a cross-attention sequence consisting of cross-attention scores greater than or equal to the attention score threshold among the M cross-attention scores, where the cross-attention sequence contains N cross-attention scores, and N is a positive integer less than or equal to M. As an example, if the attention score threshold is 0.85 and a cross-attention score sequence consisting of the M cross-attention scores is (0.44, 0.99, 0.87, 0.64, 0.92, 0.66), the formed cross-attention sequence is (0.99, 0.87, 0.92). The computer equipment may obtain a transaction price to-be-updated corresponding to each of the N cross-attention scores, and determine the highest transaction price to-be-updated among N transaction prices to-be-updated as the contract update data. As an example, if transaction prices to-be-updated corresponding to the cross-attention score sequence of (0.44, 0.99, 0.87, 0.64, 0.92, 0.66) are (2400, 2500, 2600, 2700, 2800, 2900), N transaction prices to-be-updated corresponding to the cross-attention sequence of (0.99, 0.87, 0.92) are (2500, 2600, 2800), and the highest transaction price to-be-updated among the N transaction prices to-be-updated is 2800, in this case, the contract update parameter is 2800.

Further, the computer equipment may obtain an image recognition result by performing image recognition on the initial transaction contract. The image recognition result contains a non-text layer and a text layer, and an initial text feature can be obtained by performing text feature extraction on the text layer in the image recognition result through image processing and machine learning techniques. Optionally, the computer equipment may further perform operations such as denoising, binarization, and tilt correction on an image corresponding to the initial transaction contract, to improve accuracy of image recognition. Further, the computer equipment may obtain a character segmentation feature by performing character segmentation on the initial text feature, and obtain text information by performing character recognition on the character segmentation feature. That is, the extracted character segmentation feature is matched with a template to recognize a text corresponding to the character segmentation feature, to obtain the final text information. The text information may be typeset and proofread to obtain a text parsing result. The computer equipment may obtain the final text parsing result by performing image recognition on the initial transaction contract through an optical character recognition (OCR) technology.

The computer equipment may determine, in the text parsing result, a field to-be-updated which matches the predicted transaction price, obtain an updated text parsing result by replacing the field to-be-updated in the text parsing result with the contract update data, and obtain the updated transaction contract by fusing a non-text layer corresponding to the initial transaction contract with the updated text parsing result, where the non-text layer refers to an image of the initial transaction contract subjected to removal of the text parsing result.
S403, generate a transaction order according to the updated transaction contract, send the transaction order to the first object, and send first invoicing critical data in the transaction order to an invoicing node in blockchain, so that the invoicing node generates a first block to-be-chained according to the first invoicing critical data, where the transaction order contains the updated transaction contract and a contract signature generated for the updated transaction contract.

In embodiments of the disclosure, for the details of the implementation process of the operations at S403, reference can be made to the specific description of the implementation process of the operations at S303 in FIG. 3, which will not be repeated herein.
S404, in response to detecting that a second block to-be-chained has been created at the invoicing node, verify transaction data and transaction signature in the second block, where the transaction data indicates to transfer transaction funds in an account address of the first object to an account address of a main object, and a parent block hash in a block header of the second block is a block hash of the first block.

In embodiments of the disclosure, for the details of the implementation process of the operations at S404, reference can be made to the specific description of the implementation process of the operations at S304 in FIG. 3, which will not be repeated herein.
S405, in response to verifying that a value of transaction funds in the transaction data matches a value of contract funds in the updated transaction contract and the transaction signature is identical with the contract signature, sequentially chain the first block and the second block, generate, according to the chained first block, a first electronic invoice corresponding to the transaction order and send the first electronic invoice to the first object, and update, according to the chained second block, an account balance of the first object and an account balance of the main object in a state tree of the blockchain.

In embodiments of the disclosure, if the computer equipment verifies that the value of the transaction funds in the transaction data matches the value of the contract funds in the updated transaction contract and the transaction signature is identical with the contract signature, the computer equipment sequentially chains the first block and the second block, that is, the first block and the second block at the invoicing node are sent to a consensus node in the blockchain for consensus, and the chaining of the first block and the second block is completed after the consensus is completed. The computer equipment may obtain the first invoicing critical data for the transaction order in the chained first block, and generate a first invoicing command for the first invoicing critical data. The first invoicing command contains the first invoicing critical data, that is, the computer equipment needs to create a machine instruction that can be recognized by the machine for the first invoicing critical data. Further, the first invoicing command is sent to an invoicing processing component, so that the invoicing processing component adds the first invoicing command to an invoicing processing sequence, where the invoicing processing sequence contains one or more invoicing commands, and the first invoicing command is at the end of the invoicing processing sequence; the invoicing processing component performs, according to positions of invoicing commands in the invoicing processing sequence, invoicing on each of the invoicing commands in the invoicing processing sequence. In a normal situation, the invoicing commands in the invoicing processing sequence are sorted according to the adding order or the timestamp of the invoicing commands, and the invoicing processing component needs to process the invoicing commands one by one according to the timestamp of the invoicing commands. After the invoicing processing component completes invoicing for an invoicing command before the first invoicing command, the invoicing processing component performs invoicing for the first invoicing command, a processing result for the first invoicing command is obtained from the invoicing processing component, and the processing result is determined as the first electronic invoice corresponding to the transaction order.

Optionally, in an abnormal situation, for example, the computer equipment obtains an urgency level corresponding to the transaction order by performing an urgency-degree detection on the transaction order corresponding to the first invoicing command. If the urgency level is greater than or equal to an urgency-degree threshold, the computer equipment is considered to need to expedite processing of the first invoicing command. In this case, the computer equipment generates a priority invoicing request for the transaction order, and sends the priority invoicing request to a first processing node, so that the first processing node generates an invoicing notification for the priority invoicing request. The invoicing notification indicates whether the priority invoicing request is approved. As an example, if the first processing node determines that the first invoicing command can be processed expeditiously, “priority invoicing request passed (approved)” is determined as the invoicing notification; conversely, if the first processing node determines that the first invoicing command cannot be processed expeditiously, “priority invoicing request not passed (denied)” is determined as the invoicing notification. When the invoicing notification indicates that the priority invoicing request is passed, the computer equipment informs the invoicing processing component to move the first invoicing command to the top of the invoicing processing sequence. Subsequently, the invoicing processing component prioritize processing of the first invoicing command to complete expedited processing for the first invoicing command.

Specifically, the computer equipment obtains the urgency level corresponding to the transaction order by performing the urgency-degree detection on the transaction order corresponding to the first invoicing command as follows. The computer equipment determines an influence factor affecting urgency degree of the transaction order corresponding to the first invoicing command, obtains urgency-degree influence data associated with the influence factor from the transaction order, inputs the urgency-degree influence data into an urgency-degree evaluation model, and obtains an influence data feature by performing feature extraction on the urgency-degree influence data through the urgency-degree evaluation model. The influence factor may include a delivery deadline of an order, importance of a customer (first object), order amount (contract update parameter, transaction funds), inventory status, etc. Further, the computer equipment obtains B urgency-degree labels and label levels corresponding to the B urgency-degree labels, and obtains a label-feature sequence consisting of B label features by performing feature extraction on the B urgency-degree labels, where B is a positive integer. The urgency-degree label may be “extremely high”, “high”, “medium”, “low”, “extremely low”, etc. The computer equipment obtains an urgency-degree attention sequence consisting of B attention scores by performing cross-attention processing on the influence data feature and the label-feature sequence, where the cross-attention processing can be referred to the formula (1), which will not be repeated herein. Further, the computer equipment determines an urgency-degree label corresponding to the highest attention score in the urgency-degree attention sequence as a target urgency-degree label, and determines a label level corresponding to the target urgency-degree label as the urgency level corresponding to the transaction order, where the B urgency-degree labels include the target urgency-degree label.
S406, in response to receiving a second electronic invoice sent by a second object, obtain an account address of the second object, obtain assets to-be-transferred corresponding to a transaction value from digital assets corresponding to an account of the main object, and transfer the assets to-be-transferred to the account address of the second object.

In embodiments of the disclosure, when the computer equipment receives the second electronic invoice sent by the second object, the computer equipment can obtain second invoicing critical data in the second electronic invoice, traverse blocks in the blockchain according to the second invoicing critical data, and determine that the second electronic invoice passes a legitimacy test if a target block containing the second invoicing critical data is traversed. That is, the computer equipment detects whether the second electronic invoice exists in the blockchain to verify legitimacy of the second electronic invoice. The second object may be one or more employee objects in a company corresponding to the main object. The computer equipment can obtain a third object indicated in the second invoicing critical data, and determine that the second electronic invoice passes a compliance test if the third object is an associated object of the main object. The third object refers to a payee indicated in the second electronic invoice. When a transaction is completed between the second object and the third object, if the third object is the associated object of the main object, actual transaction parties of the completed transaction are the main object and the third object, and the payment behavior of the second object is an advance payment behavior, in this case, the compliance test for the second electronic invoice is determined to be passed. If the second electronic invoice passes both the legitimacy test and the compliance test, the computer equipment obtains a transaction value corresponding to the second electronic invoice (the amount paid by the second object to the third object) from the target block, further obtains an account address of the second object, obtains assets to-be-transferred corresponding to the transaction value from digital assets corresponding to an account of the main object, and transfers the assets to-be-transferred to the account address of the second object. In essence, the entire process represents a process of reimbursement of an electronic invoice (i.e., receipt). After the second object pays to the third object a payable (which is actually payable by the main object to the third object), the second object obtains digital assets corresponding to the payable from the main object according to the second electronic invoice.
S407, obtain an electronic-invoice set associated with the main object, and generate financial statements for the main object according to the electronic-invoice set.

In embodiments of the disclosure, the computer equipment can obtain the electronic-invoice set associated with the main object, where the electronic-invoice set contains a payment electronic invoice(s) (invoice issued by a transaction party) and a receipt electronic invoice(s) (invoice issued by the main object to the transaction party), the payment electronic invoice includes the second electronic invoice, and the receipt electronic invoice includes the first electronic invoice. Further, the computer equipment can obtain transaction record information of the account corresponding to the main object, that is, receipt information and payment information of the main object. The computer equipment can perform data verification on the electronic-invoice set according to the transaction record information, that is, verifying whether receipt information in the transaction record information of the account corresponding to the main object includes receivable data in the receipt electronic invoice, and verifying whether payment information in the transaction record information of the account corresponding to the main object includes payable data in the payment electronic invoice. The computer equipment can determine, in the electronic-invoice set, an electronic invoice passing data verification as an actual electronic invoice.

Further, the computer equipment may generate the financial statements for the main object according to actual electronic invoices. Specifically, the computer equipment obtains P expenditure electronic invoices and Q income electronic invoices by classifying the actual electronic invoices according to an invoice type, where P and Q each are a positive integer. The computer equipment extracts expenditure transaction data from each of the P expenditure electronic invoices and a business type corresponding to the expenditure transaction data, and obtains P updated expenditure transaction data by adding a first type character to each of P expenditure transaction data, where the first type character represents a data type of the updated expenditure transaction data. For example, the first type character is “−”, when expenditure transaction data in an expenditure electronic invoice is 4000, updated expenditure transaction data corresponding to the expenditure electronic invoice can be expressed as “−4000”, which indicates that the main object has incurred an expenditure of 4000 or made a payment of 4000, that is, a value of account balance of the main object has decreased by 4000.

The computer equipment extracts income transaction data from each of the Q income electronic invoices and a business type corresponding to the income transaction data, and obtains Q updated income transaction data by adding a second type character to each of Q income transaction data, where the second type character represents a data type of the updated income transaction data. For example, the second type character is “+”, when income transaction data in an income electronic invoice is 80000, updated income transaction data corresponding to the income electronic invoice can be expressed as “+80000”, which indicates that the main object has received an income or payment of 80000, that is, the value of the account balance of the main object has increased by 80000. Subsequently, the computer equipment draws the financial statements for the main object by using the P updated expenditure transaction data, the business type corresponding to each of the P updated expenditure transaction data, the Q updated income transaction data, and the business type corresponding to each of the Q updated income transaction data. The computer equipment may generate corresponding financial statements by using the aforementioned data as instruction text through the text-to-image model, or select appropriate data visualization tools or libraries for drawing, such as Excel, Tableau, Power BI, Python's Matplotlib, etc., which is not limited herein.

It is to be understood that, before drawing, the computer equipment also needs to determine a basic structure of the financial statements, including balance sheets, income statements, cash flow statements, etc., and determine key indicators to be displayed, such as total revenue, total expenses, net profit, total assets, total liabilities, etc.
S408, obtain a business analysis request, and generate a target business analysis result for the business analysis request.

In embodiments of the disclosure, the computer equipment may obtain the business analysis request, obtain, according to the business analysis request, a business analysis template indicated by the business analysis request from the business template library, and input the business analysis request, the financial statements, and the business analysis template into a large language model. The computer equipment may obtain business semantic information by performing semantic parsing on the business analysis request through the large language model, that is, determining what the business analysis request is, what needs to be done, etc. The computer equipment may generate an initial business analysis result for the business analysis request according to the business semantic information and the financial statements, that is, obtaining the initial business analysis result by analyzing data in the financial statements according to the business semantic information. For instance, changing trends and potential problems of financial status are identified, or explanations and discussions of the financial statements are prepared, so as to report to stakeholders (e.g., management, investors, or auditors).

The computer equipment may determine A fields to-be-supplemented in the business analysis template, obtain context information of each of the A fields to-be-supplemented, and obtain a business analysis field corresponding to each of the A fields to-be-supplemented by segmenting the initial business analysis result according to A context information, where A is a positive integer. The field to-be-supplemented may be a field in the business analysis template that need to be filled in according to specific data (e.g., the initial business analysis result). The computer equipment may obtain a target business analysis result for the business analysis request by replacing the A fields to-be-supplemented in the business analysis template with business analysis fields corresponding to the A fields to-be-supplemented.

As such, the initial transaction contract is generated according to the pending-transaction business data and the predicted transaction price for the pending-transaction business data, the feedback information is obtained by directly sending the initial transaction contract to the first object, and the updated transaction contract is obtained by updating the initial transaction contract according to the feedback information, which can avoid unnecessary multiple information interaction processes, thereby shortening transaction completion time; in addition, after the transaction order is generated, a corresponding first block to-be-chained is generated according to the first invoicing critical data corresponding to the transaction order, so that in response to detecting that the second block (containing the transaction data for the transaction order) has been created, that is, when the first object agrees to the transaction order, a corresponding electronic invoice can be obtained by directly chaining the two blocks, thereby improving invoicing efficiency. Furthermore, the first invoicing critical data obtained by the computer equipment from the transaction order includes all critical data for generating the electronic invoice, thereby reducing omission rate of manually obtaining the first invoicing critical data; moreover, the first invoicing critical data is automatically inputted by the computer equipment into the electronic invoice template to generate the final electronic invoice, which not only reduces time required for manual input but also lowers an error rate. The computer equipment can identify the second invoicing critical data in the second electronic invoice accurately, and perform legitimacy verification and compliance verification, which can reduce errors in manual review. Also, the financial statements and the target business analysis result can be generated according to the electronic-invoice set, without manual drawing and manual analysis, thereby saving labor costs.

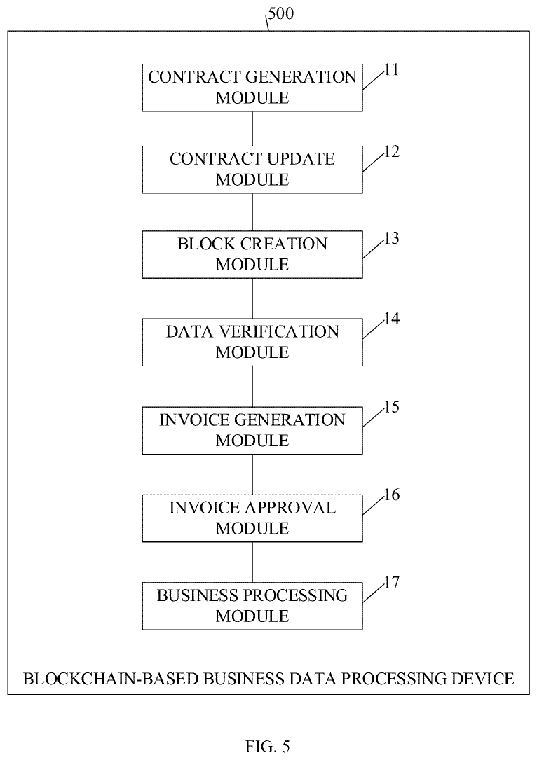

Further, referring to FIG. 5, FIG. 5 is a schematic diagram illustrating a blockchain-based business data processing device provided in embodiments of the disclosure. The blockchain-based business data processing device may be a computer program (including program code) running on a computer equipment. For example, the blockchain-based business data processing device is an application software. The blockchain-based business data processing device can be configured to execute the corresponding operations of the method provided in embodiments of the disclosure. As illustrated in FIG. 5, the blockchain-based business data processing device 500 can be used for the computer equipment in the embodiments corresponding to FIG. 3 and FIG. 4. Specifically, the blockchain-based business data processing device includes a contract generation module 11, a contract update module 12, a block creation module 13, a data verification module 14, an invoice generation module 15, an invoice approval module 16, a business processing module 17. The contract generation module 11 is configured to obtain pending-transaction business data sent by a first object, obtain a predicted transaction price for the pending-transaction business data by performing price prediction on the pending-transaction business data, generate an initial transaction contract according to the predicted transaction price and the pending-transaction business data, and send the initial transaction contract to the first object, so that the first object generates feedback information according to the initial transaction contract. The contract update module 12 is configured to obtain the feedback information sent by the first object, predict, according to the feedback information, contract update data that meets a transaction-success-rate condition, and obtain an updated transaction contract by updating the initial transaction contract according to the contract update data. The block creation module 13 is configured to generate a transaction order according to the updated transaction contract, send the transaction order to the first object, and send first invoicing critical data in the transaction order to an invoicing node in blockchain, so that the invoicing node generates a first block to-be-chained according to the first invoicing critical data; where the transaction order contains the updated transaction contract and a contract signature generated for the updated transaction contract. The data verification module 14 is configured to verify transaction data and transaction signature in the second block, in response to detecting that a second block to-be-chained has been created at the invoicing node; where the transaction data indicates to transfer transaction funds in an account address of the first object to an account address of a main object, and a parent block hash in a block header of the second block is a block hash of the first block. The invoice generation module 15 is configured to sequentially chain the first block and the second block, generate, according to the chained first block, a first electronic invoice corresponding to the transaction order and send the first electronic invoice to the first object, and update, according to the chained second block, an account balance of the first object and an account balance of the main object in a state tree of the blockchain, in response to verifying that a value of transaction funds in the transaction data matches a value of contract funds in the updated transaction contract and the transaction signature is identical with the contract signature.

In a possible embodiment, the contract generation module 11 configured to generate the initial transaction contract according to the predicted transaction price and the pending-transaction business data is specifically configured to: obtain a contract template associated with the pending-transaction business data from a business template library, and generate a Gaussian noise image according to the contract template and initial noise data; obtain an instruction text by performing semantic expansion on the predicted transaction price and the pending-transaction business data through a large language model; input the Gaussian noise image and the instruction text into a text-to-image model, obtain a Gaussian noise feature by performing feature extraction on the Gaussian noise image through the text-to-image model, and obtain a forward noise vector by performing forward diffusion on the Gaussian noise feature; and obtain a text encoding feature by performing feature encoding on the instruction text through the text-to-image model, and obtain the initial transaction contract by denoising the Gaussian noise image according to the forward noise vector and the text encoding feature.

In a possible embodiment, the contract update module 12 is configured to predict, according to the feedback information, the contract update data that meets the transaction-completion-rate condition is specifically configured to: obtain feedback semantic data by performing semantic analysis on the feedback information, and generate an object expected price according to the feedback semantic data; obtain a price update parameter, and generate, according to the object expected price, the predicted transaction price, and the price update parameter, M transaction prices to-be-updated, where M is a positive integer; obtain historical completed transaction behavior data corresponding to each of the M transaction prices to-be-updated, and obtain M historical transaction behavior features by performing feature extraction on M historical completed transaction behavior data; obtain a transaction-pending business feature by performing feature extraction on the pending-transaction business data, and obtain M cross-attention scores by performing cross-attention processing on the transaction-pending business feature and the M historical transaction behavior features; determine an attention score threshold according to the transaction-success-rate condition, and form a cross-attention sequence consisting of cross-attention scores greater than or equal to the attention score threshold among the M cross-attention scores, where the cross-attention sequence contains N cross-attention scores, and N is a positive integer less than or equal to M; and obtain a transaction price to-be-updated corresponding to each of the N cross-attention scores, and determine the highest transaction price to-be-updated among N transaction prices to-be-updated as the contract update data.

In a possible embodiment, the contract update module 12 configured to obtain the updated transaction contract by updating the initial transaction contract according to the contract update data is specifically configured to: obtain an image recognition result by performing image recognition on the initial transaction contract, and obtain an initial text feature by performing text feature extraction on the image recognition result; obtain a character segmentation feature by performing character segmentation on the initial text feature, obtain text information by performing character recognition on the character segmentation feature, and obtain a text parsing result by typesetting the text information; and determine, in the text parsing result, a field to-be-updated which matches the predicted transaction price, obtain an updated text parsing result by replacing the field to-be-updated in the text parsing result with the contract update data, and obtain the updated transaction contract by fusing a non-text layer corresponding to the initial transaction contract with the updated text parsing result, where the non-text layer refers to an image of the initial transaction contract subjected to removal of the text parsing result.

In a possible embodiment, the invoice generation module 15 configured to generate, according to the chained first block, the first electronic invoice corresponding to the transaction order is specifically configured to: obtain the first invoicing critical data for the transaction order in the chained first block, and generate a first invoicing command for the first invoicing critical data, where the first invoicing command contains the first invoicing critical data; send the first invoicing command to an invoicing processing component, so that the invoicing processing component adds the first invoicing command to an invoicing processing sequence, where the first invoicing command is at the end of the invoicing processing sequence, and the invoicing processing component performs, according to positions of invoicing commands in the invoicing processing sequence, invoicing on each of the invoicing commands in the invoicing processing sequence; and obtain a processing result for the first invoicing command from the invoicing processing component, and determine the processing result as the first electronic invoice corresponding to the transaction order.

In a possible embodiment, the invoice generation module 15 is further configured to: obtain an urgency level corresponding to the transaction order by performing an urgency-degree detection on the transaction order corresponding to the first invoicing command; in response to the urgency level being greater than or equal to an urgency-degree threshold, generate a priority invoicing request for the transaction order, and send the priority invoicing request to a first processing node, so that the first processing node generates an invoicing notification for the priority invoicing request; and in response to the invoicing notification indicating that the priority invoicing request is passed, inform the invoicing processing component to move the first invoicing command to the top of the invoicing processing sequence.

In a possible embodiment, the invoice generation module 15 configured to obtain the urgency level corresponding to the transaction order by performing the urgency-degree detection on the transaction order corresponding to the first invoicing command is specifically configured to: determine an influence factor affecting urgency degree of the transaction order corresponding to the first invoicing command, obtain urgency-degree influence data associated with the influence factor from the transaction order, input the urgency-degree influence data into an urgency-degree evaluation model, and obtain an influence data feature by performing feature extraction on the urgency-degree influence data through the urgency-degree evaluation model; obtain B urgency-degree labels and label levels corresponding to the B urgency-degree labels, and obtain a label-feature sequence consisting of B label features by performing feature extraction on the B urgency-degree labels, where B is a positive integer; and obtain an urgency-degree attention sequence consisting of B attention scores by performing cross-attention processing on the influence data feature and the label-feature sequence, determine an urgency-degree label corresponding to the highest attention score in the urgency-degree attention sequence as a target urgency-degree label, and determine a label level corresponding to the target urgency-degree label as the urgency level corresponding to the transaction order, where the B urgency-degree labels include the target urgency-degree label.

In a possible embodiment, the blockchain-based business data processing device 500 further includes an invoice approval module 16. The invoice approval module 16 is specifically configured to: in response to receiving a second electronic invoice sent by a second object, obtain second invoicing critical data in the second electronic invoice, traverse blocks in the blockchain according to the second invoicing critical data, and determine that the second electronic invoice passes a legitimacy test in response to a target block containing the second invoicing critical data being traversed; obtain a third object indicated in the second invoicing critical data, and determine that the second electronic invoice passes a compliance test in response to the third object being an associated object of the main object; in response to the second electronic invoice passing both the legitimacy test and the compliance test, obtain a transaction value corresponding to the second electronic invoice from the target block; and obtain an account address of the second object, obtain assets to-be-transferred corresponding to the transaction value from digital assets corresponding to an account of the main object, and transfer the assets to-be-transferred to the account address of the second object.

In a possible embodiment, the blockchain-based business data processing device 500 further includes a business processing module 17. The business processing module 17 is specifically configured to: obtain an electronic-invoice set associated with the main object, and obtain transaction record information of the account corresponding to the main object, where the electronic-invoice set contains the first electronic invoice and the second electronic invoice; perform data verification on the electronic-invoice set according to the transaction record information, and determine, in the electronic-invoice set, an electronic invoice passing data verification as an actual electronic invoice; and generate financial statements for the main object according to actual electronic invoices.

In a possible embodiment, the business processing module 17 configured to generate the financial statements for the main object according to the actual electronic invoices is specifically configured to: obtain P expenditure electronic invoices and Q income electronic invoices by classifying the actual electronic invoices according to an invoice type, where P and Q each are a positive integer; extract expenditure transaction data from each of the P expenditure electronic invoices and a business type corresponding to the expenditure transaction data, and obtain P updated expenditure transaction data by adding a first type character to each of P expenditure transaction data, where the first type character represents a data type of the updated expenditure transaction data; extract income transaction data from each of the Q income electronic invoices and a business type corresponding to the income transaction data, and obtain Q updated income transaction data by adding a second type character to each of Q income transaction data, where the second type character represents a data type of the updated income transaction data; and draw the financial statements for the main object by using the P updated expenditure transaction data, the business type corresponding to each of the P updated expenditure transaction data, the Q updated income transaction data, and the business type corresponding to each of the Q updated income transaction data.

In a possible embodiment, the business processing module 17 is further configured to: obtain a business analysis request, obtain, according to the business analysis request, a business analysis template indicated by the business analysis request from the business template library, and input the business analysis request, the financial statements, and the business analysis template into a large language model; obtain business semantic information by performing semantic parsing on the business analysis request through the large language model, and generate an initial business analysis result for the business analysis request according to the business semantic information and the financial statements; determine A fields to-be-supplemented in the business analysis template, obtain context information of each of the A fields to-be-supplemented, and obtain a business analysis field corresponding to each of the A fields to-be-supplemented by segmenting the initial business analysis result according to A context information, where A is a positive integer; and obtain a target business analysis result for the business analysis request by replacing the A fields to-be-supplemented in the business analysis template with business analysis fields corresponding to the A fields to-be-supplemented.

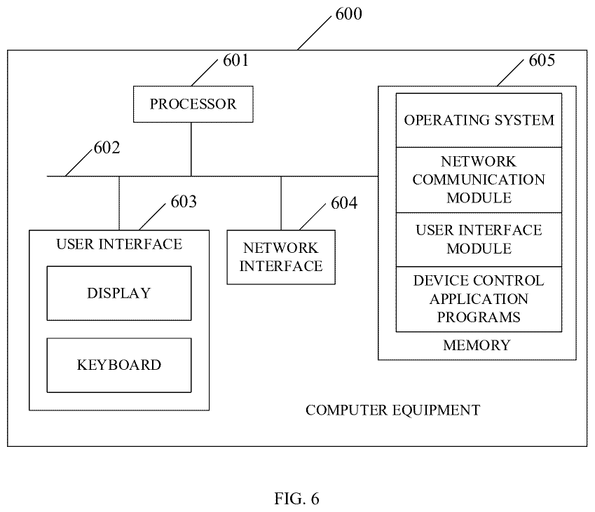

Referring to FIG. 6, FIG. 6 is a schematic structural diagram illustrating a computer equipment provided in embodiments of the disclosure. As illustrated in FIG. 6, a computer equipment 600 in embodiments of the disclosure may include a processor 601, a network interface 604, and a memory 605. In addition, the computer equipment 600 may further include a user interface 603, and at least one communication bus 602. The communication bus 602 is used to realize connection and communication among these components. The user interface 603 may include a display, and a keyboard. Optionally, the user interface 603 may also include a standard wired interface and a wireless interface. Optionally, the network interface 604 may include a standard wired interface and a wireless interface (e.g., a WI-FI interface). The memory 605 may be a high-speed random-access memory (RAM) or a non-volatile memory, such as at least one disk memory. Optionally, the memory 605 may also be at least one storage device located away from the processor 601. As illustrated in FIG. 6, the memory 605 as a computer-readable storage medium may include an operating system, a network communication module, a user interface module, and a device control application programs.

The network interface 604 can provide a network communication element. The user interface 603 is mainly used to provide an input interface for a user. The processor 601 is configured to call device control application programs stored in the memory 605 to perform the following operations: obtaining pending-transaction business data sent by a first object, obtaining a predicted transaction price for the pending-transaction business data by performing price prediction on the pending-transaction business data, generating an initial transaction contract according to the predicted transaction price and the pending-transaction business data, and sending the initial transaction contract to the first object, so that the first object generates feedback information according to the initial transaction contract; obtaining the feedback information sent by the first object, predicting, according to the feedback information, contract update data that meets a transaction-success-rate condition, and obtaining an updated transaction contract by updating the initial transaction contract according to the contract update data; generating a transaction order according to the updated transaction contract, sending the transaction order to the first object, and sending first invoicing critical data in the transaction order to an invoicing node in blockchain, so that the invoicing node generates a first block to-be-chained according to the first invoicing critical data; the transaction order containing the updated transaction contract and a contract signature generated for the updated transaction contract; in response to detecting that a second block to-be-chained has been created at the invoicing node, verifying transaction data and transaction signature in the second block; the transaction data indicating to transfer transaction funds in an account address of the first object to an account address of a main object, and a parent block hash in a block header of the second block being a block hash of the first block; and in response to verifying that a value of transaction funds in the transaction data matches a value of contract funds in the updated transaction contract and the transaction signature is identical with the contract signature, sequentially chaining the first block and the second block, generating, according to the chained first block, a first electronic invoice corresponding to the transaction order and sending the first electronic invoice to the first object, and updating, according to the chained second block, an account balance of the first object and an account balance of the main object in a state tree of the blockchain.

In addition, it should be pointed out that, embodiments of the disclosure further provide a non-transitory computer-readable storage medium. The computer-readable storage medium stores computer programs. The computer programs are suitable for being loaded by a processor and executing the operations of the method in FIG. 3 or FIG. 4. For details, reference can be made to implementation of each operation of the method in FIG. 3 or FIG. 4, which will not be repeated herein. In addition, the description of the advantageous effects based on the same method will not be repeated herein. For technical details not disclosed in embodiments of the computer-readable storage medium of the disclosure, reference can be made to the description of the method embodiments of the disclosure. As an example, the computer program may be deployed to be executed on a computer equipment, or on multiple computer equipment located at one location, or on multiple computer equipment distributed at multiple locations and interconnected by a communication network.

The computer-readable storage medium may be a device provided in any of the foregoing embodiments or an internal storage unit of the computer equipment, such as a hard disk or a memory of the computer equipment. The computer-readable storage medium may also be an external storage device of the computer equipment, such as a plug-in hard disk, a smart media card (SMC), a secure digital (SD) card, a flash card, etc. equipped on the computer equipment. Also, the computer-readable storage medium may include both the internal storage unit of the computer equipment and the external storage device. The computer-readable storage medium is used to store the computer programs, and other programs as well as data required by the computer equipment. The computer-readable storage medium can also be used to temporarily store data that has been outputted or is to be outputted.

Embodiments of the disclosure further provide a computer program product or a computer program. The computer program product or the computer program includes computer instructions stored in a computer-readable storage medium. A processor of a computer equipment is configured to read the computer instructions from the computer-readable storage medium. The processor is configured to execute the computer instructions to cause the computer equipment to execute the method provided in the various optional embodiments corresponding to FIG. 3 or FIG. 4, which will not be described in detail herein.

The terms “first”, “second”, and the like used in the specification, the claims, and the accompany drawings of the disclosure are used to distinguish different objects rather than describe a particular order. In addition, the terms “include”, “comprise”, and “have” as well as variations thereof are intended to cover non-exclusive inclusion. For example, a process, method, device, product, or equipment including a series of steps/operations or modules is not limited to the listed steps/operations or modules, on the contrary, it can optionally include steps/operations or modules that are not listed; alternatively, other steps/operations or modules inherent to the process, method, device, product, or equipment can be included either.

In embodiments of the disclosure, the terms “module” or “unit” refers to a computer program or a part of a computer program with a predetermined function, and works with other related parts to achieve a predetermined goal, and can be implemented in whole or in part by software, hardware (e.g., a processing circuit or a memory), or a combination thereof. Similarly, a processor (or multiple processors or memories) can be configured to implement one or more modules or units. In addition, each module or unit may be part of an overall module or unit that includes a function of the module or unit.

Those skilled in the art should readily recognize that, the units and scheme steps/operations of each example described in conjunction with embodiments disclosed herein can be implemented in electronic hardware, computer software, or a combination of the two. In order to clearly illustrate interchangeability of the hardware and the software, the composition and steps/operations of each example have been generally described in this description according to functions. Whether these functions are implemented in hardware or software depends on the particular application and design constraints of the technical solution. Those skilled in the art may use different methods to implement the described functions for each particular application, but such implementation should not be considered as beyond the scope of the disclosure.

The method and related device provided in embodiments of the disclosure are described with reference to the method flowchart and/or the structural diagram provided in the embodiments of the disclosure, and each process and/or block of the method flowchart and/or the structural diagram, and the combination of the process and/or block in the flowchart and/or the block diagram can be realized by computer program instructions. These computer program instructions can be provided to a processor of a general-purpose computer, a special-purpose computer, an embedded processor, or other programmable device to generate a machine, so that the instructions executed by the processor of the computer or other programmable device generate a device for realizing a function specified in one or more processes of the flowchart and/or one or more blocks of the structural diagram. These computer program instructions can also be stored in a computer-readable memory that can guide a computer or other programmable device to work in a specific manner, so that the instructions stored in the computer-readable memory generate a manufactured product including an instruction device, or are transmitted through a computer-readable storage medium. The computer instructions can be transmitted from a website site, computer, server, or data center to another website site, computer, server, or data center by wired means (e.g., coaxial cable, optical fiber, digital subscriber line (DSL)) or wireless means (e.g., infrared, radio wave, microwave). The instruction device is configured to implement the function specified in one or more processes of the flowchart and/or one or more blocks of the structural diagram. These computer program instructions can also be loaded onto a computer or other programmable device, so that a series of operation steps are executed on the computer or other programmable device to produce computer-implemented processing, so that the instructions executed on the computer or other programmable device provide steps for implementing the function specified in one or more processes of the flowchart and/or one or more blocks of the structural diagram.

The steps/operations in the method of embodiments of the disclosure can be adjusted in execution order, combined, and deleted according to actual needs.

The modules in the device of embodiments of the disclosure can be combined, divided, and deleted according to actual needs.

Embodiments of the disclosure provide a blockchain-based business data processing method and device, equipment, and a storage medium, which can improve invoicing efficiency.

In an aspect, embodiments of the disclosure provide a blockchain-based business data processing method. The method includes: obtaining pending-transaction business data sent by a first object, obtaining a predicted transaction price for the pending-transaction business data by performing price prediction on the pending-transaction business data, generating an initial transaction contract according to the predicted transaction price and the pending-transaction business data, and sending the initial transaction contract to the first object, the initial transaction contract being used for the first object to generate feedback information; obtaining the feedback information sent by the first object, predicting, according to the feedback information, contract update data that meets a transaction-success-rate condition, and obtaining an updated transaction contract by updating the initial transaction contract according to the contract update data; generating a transaction order according to the updated transaction contract, sending the transaction order to the first object, and sending first invoicing critical data in the transaction order to an invoicing node in blockchain, the first invoicing critical data being used for the invoicing node to generate a first block to-be-chained; the transaction order containing the updated transaction contract and a contract signature generated for the updated transaction contract; in response to detecting that a second block to-be-chained has been created at the invoicing node, verifying transaction data and transaction signature in the second block; the transaction data indicating to transfer transaction funds in an account address of the first object to an account address of a main object, and a parent block hash in a block header of the second block being a block hash of the first block; and in response to verifying that a value of transaction funds in the transaction data matches a value of contract funds in the updated transaction contract and the transaction signature is identical with the contract signature, sequentially chaining the first block and the second block, generating, according to the chained first block, a first electronic invoice corresponding to the transaction order and sending the first electronic invoice to the first object, and updating, according to the chained second block, an account balance of the first object and an account balance of the main object in a state tree of the blockchain.

In an aspect, embodiments of the disclosure provide a blockchain-based business data processing device. The device includes a contract generation module, a contract update module, a block creation module, a data verification module, an invoice generation module. The contract generation module is configured to obtain pending-transaction business data sent by a first object, obtain a predicted transaction price for the pending-transaction business data by performing price prediction on the pending-transaction business data, generate an initial transaction contract according to the predicted transaction price and the pending-transaction business data, and send the initial transaction contract to the first object, the initial transaction contract being used for the first object to generate feedback information. The contract update module is configured to obtain the feedback information sent by the first object, predict, according to the feedback information, contract update data that meets a transaction-success-rate condition, and obtain an updated transaction contract by updating the initial transaction contract according to the contract update data. The block creation module is configured to generate a transaction order according to the updated transaction contract, send the transaction order to the first object, and send first invoicing critical data in the transaction order to an invoicing node in blockchain, the first invoicing critical data being used for the invoicing node to generate a first block to-be-chained; the transaction order containing the updated transaction contract and a contract signature generated for the updated transaction contract. The data verification module is configured to verify transaction data and transaction signature in the second block, in response to detecting that a second block to-be-chained has been created at the invoicing node; the transaction data indicating to transfer transaction funds in an account address of the first object to an account address of a main object, and a parent block hash in a block header of the second block being a block hash of the first block. The invoice generation module is configured to sequentially chain the first block and the second block, generate, according to the chained first block, a first electronic invoice corresponding to the transaction order and send the first electronic invoice to the first object, and update, according to the chained second block, an account balance of the first object and an account balance of the main object in a state tree of the blockchain, in response to verifying that a value of transaction funds in the transaction data matches a value of contract funds in the updated transaction contract and the transaction signature is identical with the contract signature.

In a possible embodiment, the contract generation module configured to generate the initial transaction contract according to the predicted transaction price and the pending-transaction business data is specifically configured to: obtain a contract template associated with the pending-transaction business data from a business template library, and generate a Gaussian noise image according to the contract template and initial noise data; obtain an instruction text by performing semantic expansion on the predicted transaction price and the pending-transaction business data through a large language model; input the Gaussian noise image and the instruction text into a text-to-image model, obtain a Gaussian noise feature by performing feature extraction on the Gaussian noise image through the text-to-image model, and obtain a forward noise vector by performing forward diffusion on the Gaussian noise feature; and obtain a text encoding feature by performing feature encoding on the instruction text through the text-to-image model, and obtain the initial transaction contract by denoising the Gaussian noise image according to the forward noise vector and the text encoding feature.

In a possible embodiment, the contract update module configured to predict, according to the feedback information, the contract update data that meets the transaction-completion-rate condition is specifically configured to: obtain feedback semantic data by performing semantic analysis on the feedback information, and generate an object expected price according to the feedback semantic data; obtain a price update parameter, and generate, according to the object expected price, the predicted transaction price, and the price update parameter, M transaction prices to-be-updated, where M is a positive integer; obtain historical completed transaction behavior data corresponding to each of the M transaction prices to-be-updated, and obtain M historical transaction behavior features by performing feature extraction on M historical completed transaction behavior data; obtain a transaction-pending business feature by performing feature extraction on the pending-transaction business data, and obtain M cross-attention scores by performing cross-attention processing on the transaction-pending business feature and the M historical transaction behavior features; determine an attention score threshold according to the transaction-success-rate condition, and form a cross-attention sequence consisting of cross-attention scores greater than or equal to the attention score threshold among the M cross-attention scores, where the cross-attention sequence contains N cross-attention scores, and N is a positive integer less than or equal to M; and obtain a transaction price to-be-updated corresponding to each of the N cross-attention scores, and determine the highest transaction price to-be-updated among N transaction prices to-be-updated as the contract update data.

In a possible embodiment, the contract update module configured to obtain the updated transaction contract by updating the initial transaction contract according to the contract update data is specifically configured to: obtain an image recognition result by performing image recognition on the initial transaction contract, and obtain an initial text feature by performing text feature extraction on the image recognition result; obtain a character segmentation feature by performing character segmentation on the initial text feature, obtain text information by performing character recognition on the character segmentation feature, and obtain a text parsing result by typesetting the text information; and determine, in the text parsing result, a field to-be-updated which matches the predicted transaction price, obtain an updated text parsing result by replacing the field to-be-updated in the text parsing result with the contract update data, and obtain the updated transaction contract by fusing a non-text layer corresponding to the initial transaction contract with the updated text parsing result, where the non-text layer refers to an image of the initial transaction contract subjected to removal of the text parsing result.

In a possible embodiment, the invoice generation module configured to generate, according to the chained first block, the first electronic invoice corresponding to the transaction order is specifically configured to: obtain the first invoicing critical data for the transaction order in the chained first block, and generate a first invoicing command for the first invoicing critical data, where the first invoicing command contains the first invoicing critical data; send the first invoicing command to an invoicing processing component, so that the invoicing processing component adds the first invoicing command to an invoicing processing sequence, where the first invoicing command is at the end of the invoicing processing sequence, and the invoicing processing component performs, according to positions of invoicing commands in the invoicing processing sequence, invoicing on each of the invoicing commands in the invoicing processing sequence; and obtain a processing result for the first invoicing command from the invoicing processing component, and determine the processing result as the first electronic invoice corresponding to the transaction order.

In a possible embodiment, the invoice generation module is further configured to: obtain an urgency level corresponding to the transaction order by performing an urgency-degree detection on the transaction order corresponding to the first invoicing command; in response to the urgency level being greater than or equal to an urgency-degree threshold, generate a priority invoicing request for the transaction order, and send the priority invoicing request to a first processing node, so that the first processing node generates an invoicing notification for the priority invoicing request; and in response to the invoicing notification indicating that the priority invoicing request is passed, inform the invoicing processing component to move the first invoicing command to the top of the invoicing processing sequence.

In a possible embodiment, the invoice generation module configured to obtain the urgency level corresponding to the transaction order by performing the urgency-degree detection on the transaction order corresponding to the first invoicing command is specifically configured to: determine an influence factor affecting urgency degree of the transaction order corresponding to the first invoicing command, obtain urgency-degree influence data associated with the influence factor from the transaction order, input the urgency-degree influence data into an urgency-degree evaluation model, and obtain an influence data feature by performing feature extraction on the urgency-degree influence data through the urgency-degree evaluation model; obtain B urgency-degree labels and label levels corresponding to the B urgency-degree labels, and obtain a label-feature sequence consisting of B label features by performing feature extraction on the B urgency-degree labels, where B is a positive integer; and obtain an urgency-degree attention sequence consisting of B attention scores by performing cross-attention processing on the influence data feature and the label-feature sequence, determine an urgency-degree label corresponding to the highest attention score in the urgency-degree attention sequence as a target urgency-degree label, and determine a label level corresponding to the target urgency-degree label as the urgency level corresponding to the transaction order, where the B urgency-degree labels include the target urgency-degree label.

In a possible embodiment, the blockchain-based business data processing device further includes an invoice approval module. The invoice approval module is specifically configured to: in response to receiving a second electronic invoice sent by a second object, obtain second invoicing critical data in the second electronic invoice, traverse blocks in the blockchain according to the second invoicing critical data, and determine that the second electronic invoice passes a legitimacy test in response to a target block containing the second invoicing critical data being traversed; obtain a third object indicated in the second invoicing critical data, and determine that the second electronic invoice passes a compliance test in response to the third object being an associated object of the main object; in response to the second electronic invoice passing both the legitimacy test and the compliance test, obtain a transaction value corresponding to the second electronic invoice from the target block; and obtain an account address of the second object, obtain assets to-be-transferred corresponding to the transaction value from digital assets corresponding to an account of the main object, and transfer the assets to-be-transferred to the account address of the second object.

In a possible embodiment, the blockchain-based business data processing device further includes a business processing module. The business processing module is specifically configured to: obtain an electronic-invoice set associated with the main object, and obtain transaction record information of the account corresponding to the main object, where the electronic-invoice set contains the first electronic invoice and the second electronic invoice; perform data verification on the electronic-invoice set according to the transaction record information, and determine, in the electronic-invoice set, an electronic invoice passing data verification as an actual electronic invoice; and generate financial statements for the main object according to actual electronic invoices.

In a possible embodiment, the business processing module configured to generate the financial statements for the main object according to the actual electronic invoices is specifically configured to: obtain P expenditure electronic invoices and Q income electronic invoices by classifying the actual electronic invoices according to an invoice type, where P and Q each are a positive integer; extract expenditure transaction data from each of the P expenditure electronic invoices and a business type corresponding to the expenditure transaction data, and obtain P updated expenditure transaction data by adding a first type character to each of P expenditure transaction data, where the first type character represents a data type of the updated expenditure transaction data; extract income transaction data from each of the Q income electronic invoices and a business type corresponding to the income transaction data, and obtain Q updated income transaction data by adding a second type character to each of Q income transaction data, where the second type character represents a data type of the updated income transaction data; and draw the financial statements for the main object by using the P updated expenditure transaction data, the business type corresponding to each of the P updated expenditure transaction data, the Q updated income transaction data, and the business type corresponding to each of the Q updated income transaction data.

In a possible embodiment, the business processing module is further configured to: obtain a business analysis request, obtain, according to the business analysis request, a business analysis template indicated by the business analysis request from the business template library, and input the business analysis request, the financial statements, and the business analysis template into a large language model; obtain business semantic information by performing semantic parsing on the business analysis request through the large language model, and generate an initial business analysis result for the business analysis request according to the business semantic information and the financial statements; determine A fields to-be-supplemented in the business analysis template, obtain context information of each of the A fields to-be-supplemented, and obtain a business analysis field corresponding to each of the A fields to-be-supplemented by segmenting the initial business analysis result according to A context information, where A is a positive integer; and obtain a target business analysis result for the business analysis request by replacing the A fields to-be-supplemented in the business analysis template with business analysis fields corresponding to the A fields to-be-supplemented.

In an aspect, embodiments of the disclosure provide a computer equipment. The computer equipment includes a processor, a memory, and an input/output interface. The processor is connected with the memory and the input/output interface. The input/output interface is configured to receive and output data. The memory stores computer programs. The computer programs, when called by the processor, are operable with the computer equipment including the processor to execute the method in the above aspect of the embodiments of the disclosure.

In an aspect, embodiments of the disclosure provide a computer-readable storage medium. The computer-readable storage medium stores computer programs which are suitable for being loaded and executed by a processor, to cause a computer equipment including the processor to execute the method in the above aspect of the embodiments of the disclosure.

In an aspect, embodiments of the disclosure provide a computer program product or a computer program. The computer program product or the computer program includes a computer instruction. The computer instruction is stored in a computer-readable storage medium. A processor of a computer equipment is configured to read the computer instruction from the computer-readable storage medium, and configured to execute the computer instruction, to cause the computer equipment to execute the method in various optional implementations of the above aspect of the embodiments of the disclosure. In other words, the computer instruction, when executed by the processor, is operable to execute the method in various optional implementations of the above aspect of the embodiments of the disclosure.

Implementing of embodiments of the disclosure has the following advantageous effects.

In the embodiments of the disclosure, pending-transaction business data sent by a first object is obtained, a predicted transaction price for the pending-transaction business data is obtained by performing price prediction on the pending-transaction business data, an initial transaction contract is generated according to the predicted transaction price and the pending-transaction business data, and the initial transaction contract is sent to the first object, so that the first object generates feedback information according to the initial transaction contract; the feedback information sent by the first object is obtained, contract update data that meets a transaction-success-rate condition is predicted according to the feedback information, and an updated transaction contract is obtained by updating the initial transaction contract according to the contract update data; a transaction order is generated according to the updated transaction contract, the transaction order is sent to the first object, and first invoicing critical data in the transaction order is sent to an invoicing node in blockchain, so that the invoicing node generates a first block to-be-chained according to the first invoicing critical data, where the transaction order contains the updated transaction contract and a contract signature generated for the updated transaction contract; in response to detecting that a second block to-be-chained has been created at the invoicing node, verify transaction data and transaction signature in the second block, where the transaction data indicates to transfer transaction funds in an account address of the first object to an account address of a main object, and a parent block hash in a block header of the second block is a block hash of the first block; and in response to verifying that a value of transaction funds in the transaction data matches a value of contract funds in the updated transaction contract and the transaction signature is identical with the contract signature, the first block and the second block are chained sequentially, a first electronic invoice corresponding to the transaction order is generated according to the chained first block and the first electronic invoice is sent to the first object, and an account balance of the first object and an account balance of the main object in a state tree of the blockchain are updated according to the chained second block. As such, the initial transaction contract is generated according to the pending-transaction business data and the predicted transaction price for the pending-transaction business data, the feedback information is obtained by directly sending the initial transaction contract to the first object, and the updated transaction contract is obtained by updating the initial transaction contract according to the feedback information, which can avoid unnecessary multiple information interaction processes, thereby shortening transaction completion time; furthermore, after the transaction order is generated, a corresponding first block to-be-chained is generated according to the first invoicing critical data corresponding to the transaction order, so that in response to detecting that the second block (containing the transaction data for the transaction order) has been created, that is, when the first object agrees to the transaction order, a corresponding electronic invoice can be obtained by directly chaining the two blocks, thereby improving invoicing efficiency.

The above depicts only exemplary embodiments of the disclosure, which, however, should not constitute any limitation to the scope of the disclosure. Therefore, equivalent substitutes made according to the claims of the disclosure shall all fall in the scope of the disclosure.

1. A blockchain-based business data processing method, performed by a computer equipment, the method comprising:
obtaining pending-transaction business data sent by a first user terminal (UE) corresponding to a first object, obtaining a predicted transaction price for the pending-transaction business data by performing price prediction on the pending-transaction business data, generating an initial transaction contract according to the predicted transaction price and the pending-transaction business data, and sending the initial transaction contract to the first UE, the first object being an invoice recipient or a payer of a transaction;
obtaining feedback information from the first UE, predicting, according to the feedback information, contract update data that meets a transaction-success-rate condition, and obtaining an updated transaction contract by updating the initial transaction contract according to the contract update data, the feedback information comprising feedback of the first object on the predicted transaction price in the initial transaction contract, and the transaction-success-rate condition representing a condition for the probability of reaching a transaction with the first object;
generating a transaction order containing the updated transaction contract and a contract signature generated for the updated transaction contract, and simultaneously sending the transaction order to the first UE and sending first invoicing critical data in the transaction order to an invoicing node in blockchain, the first invoicing critical data comprising all critical data for generating an electronic invoice, and being used for the invoicing node to generate a first block to-be-chained;
in response to detecting that a second block to-be-chained has been created at the invoicing node, verifying whether a value of transaction funds in transaction data contained in the second block is identical with a value of contract funds in the updated transaction contract obtained by the computer equipment, and verifying whether a transaction signature contained in the second block is identical with the contract signature, wherein the second block to-be-chained is created in response to the transaction data and the transaction signature being received from the first UE, the transaction data indicates to transfer transaction funds in an account address of the first object to an account address of a main object corresponding to the computer equipment, and a parent block hash in a block header of the second block is a block hash of the first block; and
in response to verifying that the value of the transaction funds in the transaction data is identical with the value of the contract funds in the updated transaction contract and the transaction signature is identical with the contract signature, sequentially chaining the first block and the second block, generating, according to the chained first block, a first electronic invoice corresponding to the transaction order and sending the first electronic invoice to the first UE, and updating, according to the chained second block, an account balance of the first object and an account balance of the main object in a state tree of the blockchain,
wherein predicting, according to the feedback information, the contract update data that meets the transaction-completion-rate condition comprises:
obtaining feedback semantic data by performing semantic analysis on the feedback information, and generating an object expected price according to the feedback semantic data;
obtaining a price update parameter, and generating, according to the object expected price, the predicted transaction price, and the price update parameter, M transaction prices to-be-updated, wherein M is a positive integer;
obtaining historical completed transaction behavior data corresponding to each of the M transaction prices to-be-updated, and obtaining M historical transaction behavior features by performing feature extraction on M historical completed transaction behavior data;
obtaining a transaction-pending business feature by performing feature extraction on the pending-transaction business data, and obtaining M cross-attention scores by performing cross-attention processing on the transaction-pending business feature and the M historical transaction behavior features;
determining an attention score threshold according to the transaction-success-rate condition, and forming a cross-attention sequence consisting of cross-attention scores greater than or equal to the attention score threshold among the M cross-attention scores, wherein the cross-attention sequence contains N cross-attention scores, and N is a positive integer less than or equal to M; and
obtaining a transaction price to-be-updated corresponding to each of the N cross-attention scores, and determining the highest transaction price to-be-updated among N transaction prices to-be-updated as the contract update data.

2. The method of claim 1, wherein generating the initial transaction contract according to the predicted transaction price and the pending-transaction business data comprises:
obtaining a contract template associated with the pending-transaction business data from a business template library, and generating a Gaussian noise image according to the contract template and initial noise data;
obtaining an instruction text by performing semantic expansion on the predicted transaction price and the pending-transaction business data through a large language model;
inputting the Gaussian noise image and the instruction text into a text-to-image model, obtaining a Gaussian noise feature by performing feature extraction on the Gaussian noise image through the text-to-image model, and obtaining a forward noise vector by performing forward diffusion on the Gaussian noise feature; and
obtaining a text encoding feature by performing feature encoding on the instruction text through the text-to-image model, and obtaining the initial transaction contract by denoising the Gaussian noise image according to the forward noise vector and the text encoding feature.

3. (canceled)

4. The method of claim 1, wherein obtaining the updated transaction contract by updating the initial transaction contract according to the contract update data comprises:
obtaining an image recognition result by performing image recognition on the initial transaction contract, and obtaining an initial text feature by performing text feature extraction on the image recognition result;
obtaining a character segmentation feature by performing character segmentation on the initial text feature, obtaining text information by performing character recognition on the character segmentation feature, and obtaining a text parsing result by typesetting the text information; and
determining, in the text parsing result, a field to-be-updated which matches the predicted transaction price, obtaining an updated text parsing result by replacing the field to-be-updated in the text parsing result with the contract update data, and obtaining the updated transaction contract by fusing a non-text layer corresponding to the initial transaction contract with the updated text parsing result, wherein the non-text layer refers to an image of the initial transaction contract subjected to removal of the text parsing result.

5. The method of claim 1, wherein generating, according to the chained first block, the first electronic invoice corresponding to the transaction order comprises:
obtaining the first invoicing critical data for the transaction order in the chained first block, and generating a first invoicing command for the first invoicing critical data, wherein the first invoicing command contains the first invoicing critical data;
sending the first invoicing command to an invoicing processing component, so that the invoicing processing component adds the first invoicing command to an invoicing processing sequence, wherein the first invoicing command is at the end of the invoicing processing sequence, and the invoicing processing component performs, according to positions of invoicing commands in the invoicing processing sequence, invoicing on each of the invoicing commands in the invoicing processing sequence; and
obtaining a processing result for the first invoicing command from the invoicing processing component, and determining the processing result as the first electronic invoice corresponding to the transaction order.

6. The method of claim 5, further comprising:
obtaining an urgency level corresponding to the transaction order by performing an urgency-degree detection on the transaction order corresponding to the first invoicing command;
in response to the urgency level being greater than or equal to an urgency-degree threshold, generating a priority invoicing request for the transaction order, and sending the priority invoicing request to a first processing node, so that the first processing node generates an invoicing notification for the priority invoicing request; and
in response to the invoicing notification indicating that the priority invoicing request is passed, informing the invoicing processing component to move the first invoicing command to the top of the invoicing processing sequence.

7. The method of claim 6, wherein obtaining the urgency level corresponding to the transaction order by performing the urgency-degree detection on the transaction order corresponding to the first invoicing command comprises:
determining an influence factor affecting urgency degree of the transaction order corresponding to the first invoicing command, obtaining urgency-degree influence data associated with the influence factor from the transaction order, inputting the urgency-degree influence data into an urgency-degree evaluation model, and obtaining an influence data feature by performing feature extraction on the urgency-degree influence data through the urgency-degree evaluation model;
obtaining B urgency-degree labels and label levels corresponding to the B urgency-degree labels, and obtaining a label-feature sequence consisting of B label features by performing feature extraction on the B urgency-degree labels, wherein B is a positive integer; and
obtaining an urgency-degree attention sequence consisting of B attention scores by performing cross-attention processing on the influence data feature and the label-feature sequence, determining an urgency-degree label corresponding to the highest attention score in the urgency-degree attention sequence as a target urgency-degree label, and determining a label level corresponding to the target urgency-degree label as the urgency level corresponding to the transaction order, wherein the B urgency-degree labels comprise the target urgency-degree label.

8. The method of claim 1, further comprising:
in response to receiving a second electronic invoice sent by a second UE corresponding to a second object, obtaining second invoicing critical data in the second electronic invoice, traversing blocks in the blockchain according to the second invoicing critical data, and determining that the second electronic invoice passes a legitimacy test in response to a target block containing the second invoicing critical data being traversed, the second object being one or more employee objects in a company corresponding to the main object;
obtaining a third object indicated in the second invoicing critical data, and determining that the second electronic invoice passes a compliance test in response to the third object being an associated object of the main object, the third object being a payee indicated in the second electronic invoice;
in response to the second electronic invoice passing both the legitimacy test and the compliance test, obtaining a transaction value corresponding to the second electronic invoice from the target block; and
obtaining an account address of the second object, obtaining assets to-be-transferred corresponding to the transaction value from digital assets corresponding to an account of the main object, and transferring the assets to-be-transferred to the account address of the second object.

9. The method of claim 8, further comprising:
obtaining an electronic-invoice set associated with the main object, and obtaining transaction record information of the account corresponding to the main object, wherein the electronic-invoice set contains the first electronic invoice and the second electronic invoice;
performing data verification on the electronic-invoice set according to the transaction record information, and determining, in the electronic-invoice set, an electronic invoice passing data verification as an actual electronic invoice; and
generating financial statements for the main object according to actual electronic invoices.

10. The method of claim 9, wherein generating the financial statements for the main object according to the actual electronic invoices comprises:
obtaining P expenditure electronic invoices and Q income electronic invoices by classifying the actual electronic invoices according to an invoice type, wherein P and Q each are a positive integer;
extracting expenditure transaction data from each of the P expenditure electronic invoices and a business type corresponding to the expenditure transaction data, and obtaining P updated expenditure transaction data by adding a first type character to each of P expenditure transaction data, wherein the first type character represents a data type of the updated expenditure transaction data;
extracting income transaction data from each of the Q income electronic invoices and a business type corresponding to the income transaction data, and obtaining Q updated income transaction data by adding a second type character to each of Q income transaction data, wherein the second type character represents a data type of the updated income transaction data; and
drawing the financial statements for the main object by using the P updated expenditure transaction data, the business type corresponding to each of the P updated expenditure transaction data, the Q updated income transaction data, and the business type corresponding to each of the Q updated income transaction data.

11. The method of claim 9, further comprising:
obtaining a business analysis request, obtaining, according to the business analysis request, a business analysis template indicated by the business analysis request from the business template library, and inputting the business analysis request, the financial statements, and the business analysis template into a large language model;
obtaining business semantic information by performing semantic parsing on the business analysis request through the large language model, and generating an initial business analysis result for the business analysis request according to the business semantic information and the financial statements;
determining A fields to-be-supplemented in the business analysis template, obtaining context information of each of the A fields to-be-supplemented, and obtaining a business analysis field corresponding to each of the A fields to-be-supplemented by segmenting the initial business analysis result according to A context information, wherein A is a positive integer; and
obtaining a target business analysis result for the business analysis request by replacing the A fields to-be-supplemented in the business analysis template with business analysis fields corresponding to the A fields to-be-supplemented.

12. A computer equipment, comprising:
a processor; and
a memory, connected with the processor and storing computer programs which, when executed by the processor, cause the processor to:
obtain pending-transaction business data sent by a first user terminal (UE) corresponding to a first object, obtain a predicted transaction price for the pending-transaction business data by performing price prediction on the pending-transaction business data, generate an initial transaction contract according to the predicted transaction price and the pending-transaction business data, and send the initial transaction contract to the first UE, the first object being an invoice recipient or a payer of a transaction;
obtain feedback information from the first UE, predict, according to the feedback information, contract update data that meets a transaction-success-rate condition, and obtain an updated transaction contract by updating the initial transaction contract according to the contract update data, the feedback information comprising feedback of the first object on the predicted transaction price in the initial transaction contract, and the transaction-success-rate condition representing a condition for the probability of reaching a transaction with the first object;
generate a transaction order containing the updated transaction contract and a contract signature generated for the updated transaction contract, and simultaneously send the transaction order to the first UE and send first invoicing critical data in the transaction order to an invoicing node in blockchain, the first invoicing critical data comprising all critical data for generating an electronic invoice, and being used for the invoicing node to generate a first block to-be-chained;
in response to detecting that a second block to-be-chained has been created at the invoicing node, verify whether a value of transaction funds in transaction data contained in the second block is identical with a value of contract funds in the updated transaction contract obtained by the computer equipment, and verify whether a transaction signature contained in the second block is identical with the contract signature, wherein the second block to-be-chained is created in response to the transaction data and the transaction signature being received from the first UE, the transaction data indicates to transfer transaction funds in an account address of the first object to an account address of a main object corresponding to the computer equipment, and a parent block hash in a block header of the second block is a block hash of the first block; and
in response to verifying that the value of the transaction funds in the transaction data is identical with the value of the contract funds in the updated transaction contract and the transaction signature is identical with the contract signature, sequentially chain the first block and the second block, generate, according to the chained first block, a first electronic invoice corresponding to the transaction order and send the first electronic invoice to the first UE, and update, according to the chained second block, an account balance of the first object and an account balance of the main object in a state tree of the blockchain,
wherein the processor configured to predict, according to the feedback information, the contract update data that meets the transaction-completion-rate condition is configured to:
obtain feedback semantic data by performing semantic analysis on the feedback information, and generate an object expected price according to the feedback semantic data;
obtain a price update parameter, and generate, according to the object expected price, the predicted transaction price, and the price update parameter, M transaction prices to-be-updated, wherein M is a positive integer;
obtain historical completed transaction behavior data corresponding to each of the M transaction prices to-be-updated, and obtain M historical transaction behavior features by performing feature extraction on M historical completed transaction behavior data;
obtain a transaction-pending business feature by performing feature extraction on the pending-transaction business data, and obtain M cross-attention scores by performing cross-attention processing on the transaction-pending business feature and the M historical transaction behavior features;
determine an attention score threshold according to the transaction-success-rate condition, and form a cross-attention sequence consisting of cross-attention scores greater than or equal to the attention score threshold among the M cross-attention scores, wherein the cross-attention sequence contains N cross-attention scores, and N is a positive integer less than or equal to M; and
obtain a transaction price to-be-updated corresponding to each of the N cross-attention scores, and determine the highest transaction price to-be-updated among N transaction prices to-be-updated as the contract update data.

13. The computer equipment of claim 12, wherein the processor configured to generate the initial transaction contract according to the predicted transaction price and the pending-transaction business data is configured to:
obtain a contract template associated with the pending-transaction business data from a business template library, and generate a Gaussian noise image according to the contract template and initial noise data;
obtain an instruction text by performing semantic expansion on the predicted transaction price and the pending-transaction business data through a large language model;
input the Gaussian noise image and the instruction text into a text-to-image model, obtain a Gaussian noise feature by performing feature extraction on the Gaussian noise image through the text-to-image model, and obtain a forward noise vector by performing forward diffusion on the Gaussian noise feature; and
obtain a text encoding feature by performing feature encoding on the instruction text through the text-to-image model, and obtain the initial transaction contract by denoising the Gaussian noise image according to the forward noise vector and the text encoding feature.

14. (canceled)

15. The computer equipment of claim 12, wherein the processor configured to obtain the updated transaction contract by updating the initial transaction contract according to the contract update data is configured to:
obtain an image recognition result by performing image recognition on the initial transaction contract, and obtain an initial text feature by performing text feature extraction on the image recognition result;
obtain a character segmentation feature by performing character segmentation on the initial text feature, obtain text information by performing character recognition on the character segmentation feature, and obtain a text parsing result by typesetting the text information; and
determine, in the text parsing result, a field to-be-updated which matches the predicted transaction price, obtain an updated text parsing result by replacing the field to-be-updated in the text parsing result with the contract update data, and obtain the updated transaction contract by fusing a non-text layer corresponding to the initial transaction contract with the updated text parsing result, wherein the non-text layer refers to an image of the initial transaction contract subjected to removal of the text parsing result.

16. The computer equipment of claim 12, wherein the processor configured to generate, according to the chained first block, the first electronic invoice corresponding to the transaction order is configured to:
obtain the first invoicing critical data for the transaction order in the chained first block, and generate a first invoicing command for the first invoicing critical data, wherein the first invoicing command contains the first invoicing critical data;
send the first invoicing command to an invoicing processing component, so that the invoicing processing component adds the first invoicing command to an invoicing processing sequence, wherein the first invoicing command is at the end of the invoicing processing sequence, and the invoicing processing component performs, according to positions of invoicing commands in the invoicing processing sequence, invoicing on each of the invoicing commands in the invoicing processing sequence; and
obtain a processing result for the first invoicing command from the invoicing processing component, and determine the processing result as the first electronic invoice corresponding to the transaction order.

17. The computer equipment of claim 16, wherein the processor is further configured to:
obtain an urgency level corresponding to the transaction order by performing an urgency-degree detection on the transaction order corresponding to the first invoicing command;
in response to the urgency level being greater than or equal to an urgency-degree threshold, generate a priority invoicing request for the transaction order, and send the priority invoicing request to a first processing node, so that the first processing node generates an invoicing notification for the priority invoicing request; and
in response to the invoicing notification indicating that the priority invoicing request is passed, inform the invoicing processing component to move the first invoicing command to the top of the invoicing processing sequence.

18. The computer equipment of claim 17, wherein the processor configured to obtain the urgency level corresponding to the transaction order by performing the urgency-degree detection on the transaction order corresponding to the first invoicing command is configured to:
determine an influence factor affecting urgency degree of the transaction order corresponding to the first invoicing command, obtain urgency-degree influence data associated with the influence factor from the transaction order, input the urgency-degree influence data into an urgency-degree evaluation model, and obtain an influence data feature by performing feature extraction on the urgency-degree influence data through the urgency-degree evaluation model;
obtain B urgency-degree labels and label levels corresponding to the B urgency-degree labels, and obtain a label-feature sequence consisting of B label features by performing feature extraction on the B urgency-degree labels, wherein B is a positive integer; and
obtain an urgency-degree attention sequence consisting of B attention scores by performing cross-attention processing on the influence data feature and the label-feature sequence, determine an urgency-degree label corresponding to the highest attention score in the urgency-degree attention sequence as a target urgency-degree label, and determine a label level corresponding to the target urgency-degree label as the urgency level corresponding to the transaction order, wherein the B urgency-degree labels comprise the target urgency-degree label.

19. The computer equipment of claim 12, wherein the processor is further configured to:
in response to receiving a second electronic invoice sent by a second UE corresponding to a second object, obtain second invoicing critical data in the second electronic invoice, traverse blocks in the blockchain according to the second invoicing critical data, and determine that the second electronic invoice passes a legitimacy test in response to a target block containing the second invoicing critical data being traversed, the second object being one or more employee objects in a company corresponding to the main object;
obtain a third object indicated in the second invoicing critical data, and determine that the second electronic invoice passes a compliance test in response to the third object being an associated object of the main object, the third object being a payee indicated in the second electronic invoice;
in response to the second electronic invoice passing both the legitimacy test and the compliance test, obtain a transaction value corresponding to the second electronic invoice from the target block; and
obtain an account address of the second object, obtain assets to-be-transferred corresponding to the transaction value from digital assets corresponding to an account of the main object, and transfer the assets to-be-transferred to the account address of the second object.

20. A non-transitory computer-readable storage medium storing computer programs which, when executed by a processor of a computer equipment, cause the computer equipment to carry out actions, comprising:
obtaining pending-transaction business data sent by a first user terminal (UE) corresponding to a first object, obtaining a predicted transaction price for the pending-transaction business data by performing price prediction on the pending-transaction business data, generating an initial transaction contract according to the predicted transaction price and the pending-transaction business data, and sending the initial transaction contract to the first UE, the first object being an invoice recipient or a payer of a transaction;
obtaining feedback information from the first UE, predicting, according to the feedback information, contract update data that meets a transaction-success-rate condition, and obtaining an updated transaction contract by updating the initial transaction contract according to the contract update data, the feedback information comprising feedback of the first object on the predicted transaction price in the initial transaction contract, and the transaction-success-rate condition representing a condition for the probability of reaching a transaction with the first object;
generating a transaction order containing the updated transaction contract and a contract signature generated for the updated transaction contract, and simultaneously sending the transaction order to the first UE and sending first invoicing critical data in the transaction order to an invoicing node in blockchain, the first invoicing critical data comprising all critical data for generating an electronic invoice, and being used for the invoicing node to generate a first block to-be-chained;
in response to detecting that a second block to-be-chained has been created at the invoicing node, verifying whether a value of transaction funds in transaction data contained in the second block is identical with a value of contract funds in the updated transaction contract obtained by the computer equipment, and verifying whether a transaction signature contained in the second block is identical with the contract signature, wherein the second block to-be-chained is created in response to the transaction data and the transaction signature being received from the first UE, the transaction data indicates to transfer transaction funds in an account address of the first object to an account address of a main object corresponding to a computer equipment, and a parent block hash in a block header of the second block is a block hash of the first block; and
in response to verifying that the value of the transaction funds in the transaction data is identical with the value of the contract funds in the updated transaction contract and the transaction signature is identical with the contract signature, sequentially chaining the first block and the second block, generating, according to the chained first block, a first electronic invoice corresponding to the transaction order and sending the first electronic invoice to the first UE, and updating, according to the chained second block, an account balance of the first object and an account balance of the main object in a state tree of the blockchain,
wherein the computer programs executed by the processor to carry out actions of predicting, according to the feedback information, the contract update data that meets the transaction-completion-rate condition are executed by the processor to carry out actions, comprising:
obtaining feedback semantic data by performing semantic analysis on the feedback information, and generating an object expected price according to the feedback semantic data;
obtaining a price update parameter, and generating, according to the object expected price, the predicted transaction price, and the price update parameter, M transaction prices to-be-updated, wherein M is a positive integer;
obtaining historical completed transaction behavior data corresponding to each of the M transaction prices to-be-updated, and obtaining M historical transaction behavior features by performing feature extraction on M historical completed transaction behavior data;
obtaining a transaction-pending business feature by performing feature extraction on the pending-transaction business data, and obtaining M cross-attention scores by performing cross-attention processing on the transaction-pending business feature and the M historical transaction behavior features;
determining an attention score threshold according to the transaction-success-rate condition, and forming a cross-attention sequence consisting of cross-attention scores greater than or equal to the attention score threshold among the M cross-attention scores, wherein the cross-attention sequence contains N cross-attention scores, and N is a positive integer less than or equal to M; and
obtaining a transaction price to-be-updated corresponding to each of the N cross-attention scores, and determining the highest transaction price to-be-updated among N transaction prices to-be-updated as the contract update data.

21. The non-transitory computer-readable storage medium of claim 20, wherein the computer programs executed by the processor to carry out actions of obtaining the updated transaction contract by updating the initial transaction contract according to the contract update data are executed by the processor to carry out actions, comprising:
obtaining an image recognition result by performing image recognition on the initial transaction contract, and obtaining an initial text feature by performing text feature extraction on the image recognition result;
obtaining a character segmentation feature by performing character segmentation on the initial text feature, obtaining text information by performing character recognition on the character segmentation feature, and obtaining a text parsing result by typesetting the text information; and
determining, in the text parsing result, a field to-be-updated which matches the predicted transaction price, obtaining an updated text parsing result by replacing the field to-be-updated in the text parsing result with the contract update data, and obtaining the updated transaction contract by fusing a non-text layer corresponding to the initial transaction contract with the updated text parsing result, wherein the non-text layer refers to an image of the initial transaction contract subjected to removal of the text parsing result.

22. The non-transitory computer-readable storage medium of claim 20, wherein the computer programs executed by the processor to carry out actions of generating, according to the chained first block, the first electronic invoice corresponding to the transaction order are executed by the processor to carry out actions, comprising:
obtaining the first invoicing critical data for the transaction order in the chained first block, and generating a first invoicing command for the first invoicing critical data, wherein the first invoicing command contains the first invoicing critical data;
sending the first invoicing command to an invoicing processing component, so that the invoicing processing component adds the first invoicing command to an invoicing processing sequence, wherein the first invoicing command is at the end of the invoicing processing sequence, and the invoicing processing component performs, according to positions of invoicing commands in the invoicing processing sequence, invoicing on each of the invoicing commands in the invoicing processing sequence; and
obtaining a processing result for the first invoicing command from the invoicing processing component, and determining the processing result as the first electronic invoice corresponding to the transaction order.
